(19) United States
(12) Patent Application Publication
(10) Pub. No.: US 2017/0161433 A1
(43) Pub. Date: Jun. 8, 2017

(54) HEALTHCARE APPLICATION CONNECTING PATIENTS TO EMERGENCY AND URGENT CARE CENTERS, AND PROVIDING EXPEDITED PATIENT CHECK-IN

(71) Applicant: Foxhall Wythe LLC, Brooklyn, NY (US)

(72) Inventor: Michael Perretta, Brooklyn, NY (US)

(73) Assignee: Foxhall Wythe LLC, Brooklyn, NY (US)

(21) Appl. No.: 15/053,494

(22) Filed: Feb. 25, 2016

Related U.S. Application Data
(60) Provisional application No. 62/287,991, filed on Jan. 28, 2016.
(60) Provisional application No. 62/262,132, filed on Dec. 2, 2015.

(51) Int. Cl. G06F 19/00

(52) U.S. Cl. CPC G06F 19/322; G06F 19/327; G06F 19/363; G06F 19/321; G06F 19/3406

(57) ABSTRACT

A method for connecting a patient to a plurality of healthcare facilities in proximity to the patient includes providing a web-based interface portal for medical professionals of each of the plurality of healthcare facilities and providing a mobile application for the patient on a mobile device, the mobile application communicating with a medical information storage database for storing patient health information. The method further includes enabling the patient to conduct a search for the plurality of healthcare facilities in proximity to the patient, in real-time, to create a location-based directory of the plurality of healthcare facilities and displaying the plurality of healthcare facilities in a prioritized manner based on a combination of estimated travel times to each of the plurality of healthcare facilities and estimated current wait times at each of the plurality of healthcare facilities. The patient then selects a healthcare facility of the plurality of healthcare facilities.

### CROSS-REFERENCE TO RELATED APPLICATIONS

This application claims the benefit of the filing date of and priority to U.S. Provisional Application Ser. No. 62/262,132 filed Dec. 2, 2015, and U.S. Provisional Application Ser. No. 62/287,991 filed Jan. 28, 2016, both of which are incorporated by reference in their entirety herein.

### BACKGROUND

Technical Field

The present disclosure relates to expedited patient registration at a healthcare facility and to a mobile application used to connect patients to the nearest healthcare facilities. More particularly, the present disclosure relates to registering at a healthcare facility via a Quick response (QR) code and to securely communicating life-saving information to healthcare professionals at the healthcare facility. Additionally, the present disclosure relates to determining healthcare facilities within proximity of a patient based on a combination of average travel time and average wait time.

Description of Related Art

Emergency departments across the U.S. are under great strain as patient demand is continually rising and economic pressures mount. An unwelcome aspect of this is that patients are often required to wait for longer periods of time creating much dissatisfaction. Lengthy and complicated registration processes in most hospital ERs add to the frustration and often unnecessarily extend the patent waiting time.

To receive medical care, a patient is received within a medical facility in a procedure known as “patient intake.” During patient intake, the patient typically has to arrive in advance of the scheduled appointment time to fill out a form with current contact and insurance information (even if it had not changed since the last visit), and fill out a medical history questionnaire, including current symptoms. This data is then manually entered into a database or the forms are simply added to the paper file. Even in emergency rooms, where a patient may be suffering a life-threatening problem, the patient must go through some level of patient intake that takes a significant amount of time. Because current patient intake methods are so slow, patients can sometimes be forced to wait several hours before they actually receive any medical treatment.

Therefore, it is an object of the present invention to provide a method that enhances the speed and efficiency of patient intake. It is also an object of the present invention to provide a method of patient intake that could be used at any healthcare facility that provides patient care. It is a further object of the present invention to connect patients to healthcare facilities such that patients experience the least amount of wait time.

### SUMMARY

Embodiments of the present disclosure are described in detail with reference to the drawing figures wherein like reference numerals identify similar or identical elements.

An aspect of the present disclosure provides a method for connecting a patient to a plurality of healthcare facilities in proximity to the patient, the method including providing a web-based interface portal for medical professionals of each of the plurality of healthcare facilities and providing a mobile application for the patient on a mobile device, the mobile application communicating with a medical information storage database for storing patient health information. The method further includes the steps of enabling the patient to conduct a search for the plurality of healthcare facilities in proximity to the patient, in real-time, to create a location-based directory of the plurality of healthcare facilities, and displaying the plurality of healthcare facilities in a prioritized manner based on a combination of estimated travel times to each of the plurality of healthcare facilities and estimated current wait times at each of the plurality of healthcare facilities. The method further includes the steps of enabling the patient to select a healthcare facility of the plurality of healthcare facilities, providing at least one transportation option to the patient to the selected healthcare facility, and notifying the selected healthcare facility of potential surges in patient volume based on one or more inputs by the patient received by the mobile application.

In one aspect, the method further includes enabling the patient to register with the mobile application by inputting at least personal information and medical history information thereto.

In another aspect, the method further includes enabling the medical professionals to create a Quick Response (QR) code via the web-based interface portal, the mobile application on the mobile device of the patient configured to communicate with the QR code when the patient arrives at the selected healthcare facility.

In yet another aspect, a range for determining the proximity of the plurality of healthcare facilities to the patient is adjusted by the patient.

In one aspect, the one or more inputs include placing a call for emergency transportation, placing a call for non-emergency transportation, and loading mapping results derived from prioritizing the plurality of healthcare facilities.

In another aspect, the method further includes continuously and automatically updating the patient health information based on data or information received from wearable devices operated by the patient.

In yet another aspect, the method further includes transmitting periodic reminders to the patient to update the patient health information.

In yet another aspect, after the patient selects the healthcare facility, the patient is notified of alternative healthcare facilities within proximity to the patient. The alternative healthcare facilities are urgent care centers.

In yet another aspect, before the at least one transportation option is selected, the patient transmits the patient health information to the selected healthcare facility.

In yet another aspect, before the at least one transportation option is selected, the patient records a voice message to be transmitted to the selected healthcare facility indicating patient's current condition and/or patient's medical injury.

In yet another aspect, before the at least one transportation option is selected, the patient captures and transmits one or more images and/or videos of an injury to the selected healthcare facility.

In yet another aspect, the method further includes indicating whether each of the plurality of healthcare facilities in proximity to the patient is compatible with medical insurance of the patient.

Another aspect of the present disclosure provides a method for expediting patient check-in at a healthcare facility, the method including providing a web-based interface portal for medical professionals of the healthcare facility, and enabling the medical professionals to create a Quick Response (QR) code associated with the healthcare facility via the web-based interface portal. The method further includes the steps of providing a mobile application for a patient on a mobile device, the mobile application communicating with a medical information storage database for storing patient health information, establishing proximity between the mobile device of the patient including the mobile application and the healthcare facility having the QR code, and capturing the QR code of the healthcare facility via the mobile application of the mobile device. The method further includes the steps of establishing communication between the mobile application of the mobile device and the healthcare facility, and automatically transmitting patient healthcare information from the mobile application to the healthcare facility, the patient healthcare information including at least personal information and medical history information.

Certain embodiments of the present disclosure may include some, all, or none of the above advantages and/or one or more other advantages readily apparent to those skilled in the art from the drawings, descriptions, and claims included herein. Moreover, while specific advantages have been enumerated above, the various embodiments of the present disclosure may include all, some, or none of the enumerated advantages and/or other advantages not specifically enumerated above.

### BRIEF DESCRIPTION OF THE DRAWING

Various embodiments of the present disclosure are described herein below with references to the drawings, wherein:

FIG. 1 is a screenshot of a user interface for accessing a mobile application, in accordance with embodiments of the present disclosure;

FIG. 2 is a screenshot displaying a plurality of informational icons, in accordance with embodiments of the present disclosure;

FIG. 3 is a screenshot displaying a plurality of settings that may be modified by a user, in accordance with embodiments of the present disclosure;

FIG. 4 is a screenshot of a list of emergency departments (or healthcare facilities) in proximity to the user and prioritized according to a combination of estimated travel time and estimated wait time, in accordance with embodiments of the present disclosure;

FIG. 5 is a screenshot illustrating selection of an emergency department in FIG. 4, as well as transportation options available to the selected emergency department, in accordance with embodiments of the present disclosure;

FIG. 6 is a screenshot allowing the user to transmit additional information to the selected emergency department before selecting transportation options, in accordance with embodiments of the present disclosure;

FIG. 7 is a screenshot allowing the user to transmit additional information to the selected emergency department before mapping the selected emergency department, in accordance with embodiments of the present disclosure;

FIG. 8 is a screenshot listing urgent care centers available for non-emergency situations, in accordance with embodiments of the present disclosure;

FIG. 9 is a screenshot illustrating a map of the urgent care centers within a proximity of the user, in accordance with embodiments of the present disclosure;

FIG. 10 is a screenshot illustrating options for a location drop-down menu, in accordance with embodiments of the present disclosure;

FIG. 11 is a screenshot illustrating availability for a selected urgent care center, in accordance with embodiments of the present disclosure;

FIG. 12 is a screenshot illustrating a list of physicians, in accordance with embodiments of the present disclosure;

FIG. 13 is a screenshot illustrating a map of the location of the physicians listed in the screenshot of FIG. 12, in accordance with embodiments of the present disclosure;

FIG. 14 is a screenshot illustrating a schedule of a selected physician, in accordance with embodiments of the present disclosure;

FIG. 15 is a screenshot of a list of medical records of the user from different medical facilities that are accessed by the healthcare application, in accordance with embodiments of the present disclosure;

FIG. 16 is a screenshot of a list of different call centers handling associated medical records of the user that are accessed by the healthcare application, in accordance with embodiments of the present disclosure;

FIG. 17 is a screenshot prompting the user to update medical information, in accordance with embodiments of the present disclosure;

FIG. 18 is a screenshot prompting the user to check into the appointment by engaging a QR code at the healthcare facility, in accordance with embodiments of the present disclosure;

FIG. 19 is a screenshot illustrating information to be entered by the user to update medical information, in accordance with embodiments of the present disclosure;

FIG. 20 is a screenshot illustrating the QR code captured by the camera of the mobile device of the user at the healthcare facility, in accordance with embodiments of the present disclosure;

FIG. 21 is a flowchart describing the selection of an emergency department, in accordance with embodiments of the present disclosure;

FIG. 22 is a flowchart describing the mobile application suggesting alternative urgent care centers for the user, in accordance with embodiments of the present disclosure;

FIG. 23 is a flowchart describing the mobile application automatically transmitting stored user healthcare information to a selected healthcare facility, in accordance with embodiments of the present disclosure;

FIG. 24 is a flowchart describing engagement between the user and the QR code at the healthcare facility selected by the user, in accordance with embodiments of the present disclosure;

FIG. 25 is a flowchart describing the process of enabling the user to select a healthcare facility and transportation options to the selected healthcare facility, in accordance with embodiments of the present disclosure;

FIG. 26 is a flowchart describing the process of checking in at the selected healthcare facility by using the QR code, in accordance with embodiments of the present disclosure;

FIG. 27 is a screenshot of the web-based interface portal, in accordance with embodiments of the present disclosure;

FIG. 28 is a screenshot of the web-based interface portal used by patients and medical professionals at healthcare facilities, in accordance with embodiments of the present disclosure;

FIG. 29 is a screenshot of the web-based interface prompting the medical professionals to enter information regarding the healthcare facility, in accordance with embodiments of the present disclosure;

FIG. 30 is a screenshot of the web-based interface including a plurality of links, in accordance with embodiments of the present disclosure; and

FIG. 31 is a QR code displayed at a healthcare facility, the QR code to be engaged by the user when entering the healthcare facility, in accordance with embodiments of the present disclosure.

The figures depict embodiments of the present disclosure for purposes of illustration only. One skilled in the art will readily recognize from the following disclosure that alternative embodiments of the structures and methods illustrated herein may be employed without departing from the principles of the present disclosure described herein.

### DETAILED DESCRIPTION

Although the present disclosure will be described in terms of specific embodiments, it will be readily apparent to those skilled in this art that various modifications, rearrangements and substitutions may be made without departing from the spirit of the present disclosure. The scope of the present disclosure is defined by the claims appended hereto.

For the purposes of promoting an understanding of the principles of the present disclosure, reference will now be made to the exemplary embodiments illustrated in the drawings, and specific language will be used to describe the same. It will nevertheless be understood that no limitation of the scope of the present disclosure is thereby intended. Any alterations and further modifications of the inventive features illustrated herein, and any additional applications of the principles of the present disclosure as illustrated herein, which would occur to one skilled in the relevant art and having possession of this disclosure, are to be considered within the scope of the present disclosure.

The word “exemplary” is used herein to mean “serving as an example, instance, or illustration.” Any embodiment described herein as “exemplary” is not necessarily to be construed as preferred or advantageous over other embodiments. The word “example” may be used interchangeably with the term “exemplary.”

The term “processing” may refer to determining the elements or essential features or functions or processes of one or more healthcare systems communicating with a healthcare application for computational processing. The term “process” may further refer to tracking data and/or collecting data and/or manipulating data and/or examining data and/or updating data on a real-time basis in an automatic manner and/or a selective manner and/or manual manner.

The term “analyze” may refer to determining the elements or essential features or functions or processes of one or more analyzing systems for computational processing. The term “analyze” may further refer to tracking data and/or collecting data and/or manipulating data and/or examining data and/or updating data on a real-time basis in an automatic manner and/or a selective manner and/or manual manner. The term “analyze” may refer to at least decoding or deconstructing or assessing or evaluating or examining or assorting or arranging or cataloging or codifying or indexing or sorting or tabulating or dissecting at least data/information/messages.

The term “storage” may refer to data storage. “Data storage” may refer to any article or material (e.g., a hard disk) from which information may be capable of being reproduced, with or without the aid of any other article or device. “Data storage” may refer to the holding of data in an electromagnetic form for access by a computer processor. Primary storage may be data in random access memory (RAM) and other “built-in” devices. Secondary storage may be data on hard disk, tapes, and other external devices. “Data storage” may also refer to the permanent holding place for digital data, until purposely erased. “Storage” implies a repository that retains its content without power. “Storage” mostly means magnetic disks, magnetic tapes and optical discs (CD, DVD, etc.). “Storage” may also refer to non-volatile memory chips such as flash, Read-Only memory (ROM) and/or Electrically Erasable Programmable Read-Only Memory (EEPROM).

The term “module” or “unit” may refer to a self-contained component (unit or item) that may be used in combination with other components and/or a separate and distinct unit of hardware or software that may be used as a component in a system, such as a healthcare system communicating with a healthcare application. The term “module” may also refer to a self-contained assembly of electronic components and circuitry, such as a stage in a computer that may be installed as a unit. The term “module” may be used interchangeably with the term “unit.”

As used herein, the term “server” means a computer or device on a network that manages network resources, e.g., processes data coming in from a computer communications network, stores files in a database, and outputs files from a database over the computer communications network. Examples of servers include file servers, e-mail servers, and Web servers.

As used herein, a “Web site” is a site (location) on a computer communications network such as the Internet containing one or more Web pages. Most Web sites contain a “home page,” which is the main page of a Web site and usually the first screen users see when they enter the site. Home pages often offer an introduction to the material contained in the Web site and also an index or table of contents hyperlinked to related Web page documents of the site.

The term “application” is intended to have the full breadth of its ordinary meaning. The term “application” includes: 1) a software program which may be stored in a memory and is executable by a processor; or 2) a hardware configuration program useable for configuring a programmable hardware element.

As used herein, the term “medication” refers to any kind of medicine, prescription or otherwise. Further, the term “medication” includes medicine in any form, including, without limitation pills, salves, creams, powders, ointments, capsules, injectable medications, drops, vitamins and suppositories. The scope of this invention is not limited by the type, form or dosage of the medication.

The exemplary embodiments of the present disclosure relate to a mobile application and cloud-synched database. The mobile application is a healthcare application. In particular, the exemplary embodiments of the present disclosure relate to methods and systems for helping patients and families navigate complex healthcare systems, reduce costs associated with non-emergency care, and securely communicate life-saving information to healthcare professionals. The exemplary embodiments of the present disclosure further relate to a system and method for easily connecting patients to the fastest and least-expensive nearby healthcare facility. The exemplary embodiments of the present disclosure further relate to curbing expensive ambulance overuse by re-directing non-emergency traffic. Additionally, the exemplary embodiments of the present disclosure further relate to automatically transmitting personal information and healthcare information of a patient to healthcare facilities selected via the mobile application. The mobile application is a healthcare application for connecting patients to emergency and urgent care centers and for providing expedited patient check-in at a selected or targeted emergency and urgent care center.

The exemplary embodiments of the present disclosure relate to a location-based directory that improves patient access to healthcare facilities. The location-based directory includes mapping of healthcare providers and locations, and the mobile application further coordinates better transportation options for the patient, and improves on emergency response. The exemplary embodiments of the present disclosure relate to real-time decision support to advise patients on optimal care options based on at least current average wait times, current traffic patterns, appointment availability, low-cost options, and reviews of healthcare facilities. The exemplary embodiments of the present disclosure further relate to predictive analytics that alerts emergency departments and urgent care facilities of potential surges in patient volumes.

Concerning the mobile application, patients have the ability to download the Docket™ mHealth application from the Apple and Google Play App Stores. Docket™ provides patients with a graphic user interface (GUI). Patients have the ability to create unique user accounts and log on through the Docket™ mHealth application via a personal mobile device.

Concerning the patient check-in feature, the Docket™ Boarding pass feature (“Boarding pass”) allows patients to consolidate personal demographic and insurance coverage information in order to assist in patient registration and admission workflows within a healthcare setting. Furthermore, Boarding pass allows patients to disclose various types of information through the use of consolidated medical history and health assessment questionnaires. Information pertaining to patients' medical histories, chief medical complaints, diet and exercise routines, behavioral health, sexual wellness, and drug and alcohol consumption patterns is consolidated and maintained within Boarding pass.

Docket™ automatically reminds patients to update the information stored within Boarding pass on a periodic basis (based on how often the patient indicates he or she typically seeks healthcare). Additionally, Boarding pass aggregates patient-entered information as well as data sourced from Apple's HealthKit as well as various wearable fitness devices and personal health record (PHR) portals. Furthermore, Boarding pass utilizes skip logic in order to hide irrelevant questions to patients (for instance, if a patient indicates that he is male, Boarding pass hides questions relating to feminine health). Upon arrival at a care facility, patients are presented with a Docket™ Boarding pass placard with a unique QR code posted at or near the registration and/or receptionist desk. The patient then has the ability to engage the Boarding pass feature. Accordingly, the patient accesses the Docket™ mHealth application on his or her mobile device and launches a camera to scan the QR code on the Docket™ Boarding pass placard. The patient's action of scanning the QR code grants the care provider access to the content contained within that patient's Docket™ account.

Concerning the web-based interface portal, care providers access the Docket™ web portal through an internet browser. Care providers then register and create a unique Docket™ account. As such, a care provider inputs login information (e.g., e-mail and password) in addition to information related to his or her specific physician practice, urgent or emergency care facility, department, or clinic (including, but not limited to, type of care facility, health system affiliation, specialties, address, hours of operation, physician biographic information, National Provider Identifiers).

Next, a care provider inputs billing information (such as a credit card or PayPal account). Docket™ then verifies the care provider's credentials and assigns a unique account. Once a care provider is logged into his or her Docket™ account via an internet browser, he or she has the ability to print out a Boarding pass placard with a unique QR code to post at or near his or her registration and/or receptionist desk. His or her patients then have the ability to scan the aforementioned QR code via the Docket™ mHealth application using a mobile device. This action grants the care provider access to the information contained within the patient's Docket™ account through the Docket™ web portal. Care providers have the ability to log into the Docket™ web portal using their unique login credentials and access the information contained within the patient's Docket™ account (once that patient scans the QR code specific to that care provider's Docket™ account). Through the Docket™ web portal, care providers have the ability to filter certain data elements reported through the patient's Boarding pass.

For example, an Ear Nose and Throat specialist might not require the same patient-reported information as a Behavioral Health specialist. Additionally, Docket™ applies logic to score patient-reported information (in addition to the other information contained within a patient's Docket™ account) in order to identify high-risk patients. Docket™ also allows care providers to save, print, and export the content reported via each patient's Boarding pass (as .xml, .htm, .html, .xls, .xlsx, .csv, .pdf, .txt, .doc, .docx, or HL7 message). Care providers may also incorporate a link that allows patients to download the Docket™ mHealth application within automated appointment reminder e-mails. The Docket™ web portal automatically logs off within a certain amount of time of inactivity. Information managed through the Docket™ mHealth application and web portal is encrypted and complies with HIPAA standards. Care providers are charged each time a patient scans his or her corresponding QR code.

Reference will now be made in detail to embodiments of the present disclosure. While certain exemplary embodiments of the present disclosure will be described, it will be understood that it is not intended to limit the embodiments of the present disclosure to those described embodiments. To the contrary, reference to embodiments of the present disclosure is intended to cover alternatives, modifications, and equivalents as may be included within the spirit and scope of the embodiments of the present disclosure as defined by the appended claims.

FIG. 1 is a screenshot of a user interface for accessing a mobile application, in accordance with embodiments of the present disclosure.

The screenshot 100 represents a graphical user interface (GUI). The screenshot 100 includes a first textbox 110 and a second textbox 120. The first textbox 110 may prompt the user for an email address. The second textbook 120 may prompt the user for a password. The screenshot 100 may further include a button 130. Activation of the button 130 may enable the user to log into the mobile application. The mobile application may be referred to as a healthcare application. The healthcare application may be referred to as Docket™. Of course, one skilled in the art may contemplate the screenshot 100 including any type of controls, graphical controls, graphical elements, software components, and/or widgets for allowing interaction between the user and the GUI represented in screenshot 100. One skilled in the art may contemplate using any number of different GUI elements on the screenshot 100 to allow for such interaction. The term “user” may be used interchangeably with the term “patient” throughout the present disclosure.

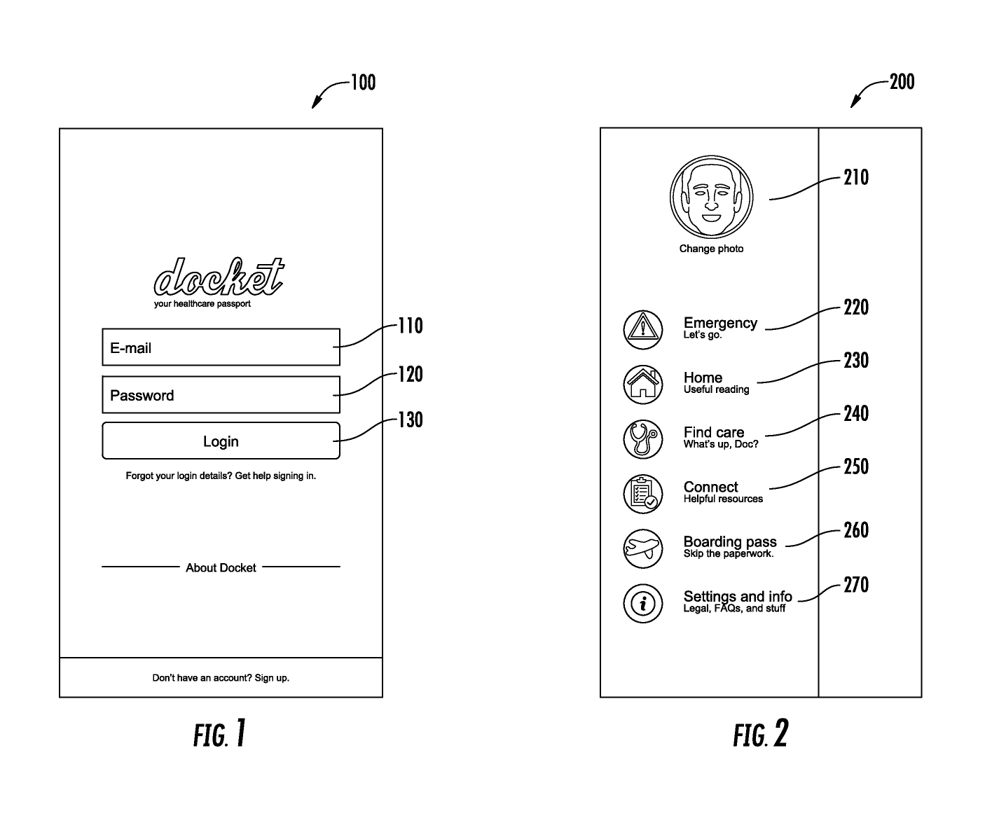

FIG. 2 is a screenshot displaying a plurality of informational icons, in accordance with embodiments of the present disclosure.

The screenshot 200 includes an image window 210. The image window 210 allows the user of the mobile application to upload a photo of the user. Of course, the user may upload any image into the image window 210. The screenshot 200 further includes a plurality of icons. Such icons may include an “Emergency” icon 220, a “Home” icon 230, a “Find care” icon 240, a “Connect” icon 250, a “Boarding pass” icon 260, and a “Setting and info” icon 270. Of course, the icons 220, 230, 240, 250, 260, 270 may be buttons or any other type of GUI element for enabling the user to select such functions.

Selection of the “Emergency” icon 220 allows the user to search for the nearest emergency department.

Selection of the “Home” icon 230 allows the user to refer back to the screenshot 100 shown in FIG. 1.

Selection of the “Find care” icon 240 allows the user to use the location-based directory of the mobile application. The location-based directory may be filtered by, for example, urgent care facilities/healthcare facilities or physicians.

Selection of the “Connect” icon 250 allows the user to contact nearby patient access services, as well as retrieve a list of patient health record (PHR) portals of nearby health systems.

Selection of the “Boarding pass” icon 260 allows the user to update a medical history questionnaire, as well as enabling expedited check-in or registration of the user at a selected emergency department (or other healthcare facility).

Selection of the “Settings and info” icon 270 allows the user to adjust the settings of the mobile application, as described in further detail with reference to FIG. 3.

FIG. 3 is a screenshot displaying a plurality of settings that may be modified by a user, in accordance with embodiments of the present disclosure.

The screenshot 300 includes a number of settings that may be adjusted by the user. The screenshot 300 is split into three sections, an “Account” section, an “About” section, and a “Sign out” section.

The “Account” section includes a plurality of first settings 310. These settings 310 include “Apple Health Medical ID,” “Search proximity,” “Uber® enabled,” “Fitbit® enabled,” “Preferred insurance carrier,” and “Change password.” The “Apple Health Medical ID” alerts the user to enable such function and prompts the user to input values into such function when the healthcare application is launched. The “Search proximity” allows the user to adjust the search proximity of the emergency departments (or healthcare facilities). In the exemplary embodiment, the search proximity has been set to a radius of 20 miles. Of course, the search proximity may be set anywhere between, say, 1 mile and 250 miles. The “Uber® enabled” function/feature allows the user to select such mobile ride hail company. Of course, any other transportation means may be built-in into the screenshot 300. The “Fitbit® enabled” function/feature allows the user to integrate information from a wearable electronic device. Of course, any other wearable device or fitness tracker device may be integrated with or communicate with Docket™. The exemplary embodiments of the present disclosure are not limited to Uber® and Fitbit®.

The “Apple Health Medical ID” is one of the lesser known, but potentially most important features of Apple's iOS 8 mobile operating system, which can provide important personal health related information in the event of an emergency. The Medical ID feature is built in to the new Health application found in iOS 8 for iPhone. Users can configure it by launching Health, tapping the Medical ID menu in the bottom right, and then choosing “Create Medical ID.” iPhone users with a passcode-locked handset can consider enabling the “Show When Locked” function, providing first responders or anyone else with emergency access to their Medical ID. Enabling this feature allows the Medical ID to be viewed by swiping the lock screen, tapping “Emergency,” and then viewing the digital information.

The “About” section includes a plurality of second settings 320. These settings 320 include “Privacy policy,” “Terms and conditions,” “Frequency asked questions,” and “About Docket™.”

The “Sign Out” section includes a third setting 330. The third setting 330 includes a “sign out” setting.

One skilled in the art may contemplate the GUI of the screenshot 300 including a plurality of different settings that are adjustable by the user of the mobile application. The settings 310, 320, 330 presented in screenshot 300 are merely exemplary, and the embodiments of the present disclosure should not be limited to only such settings.

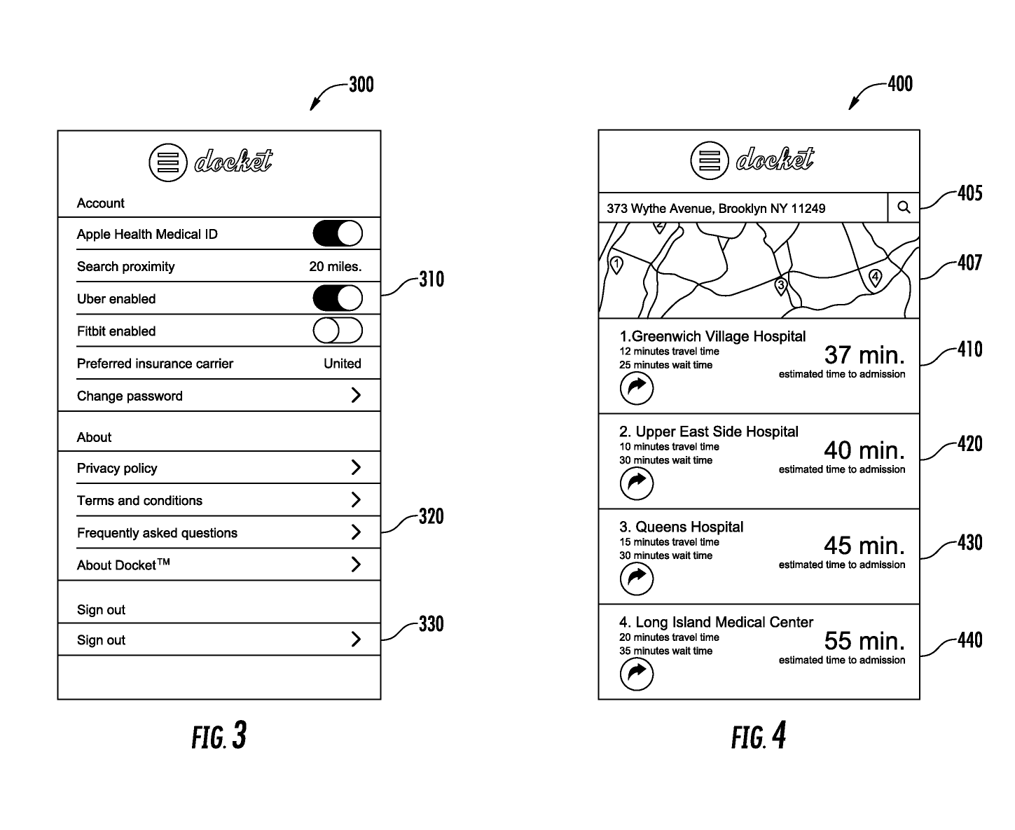

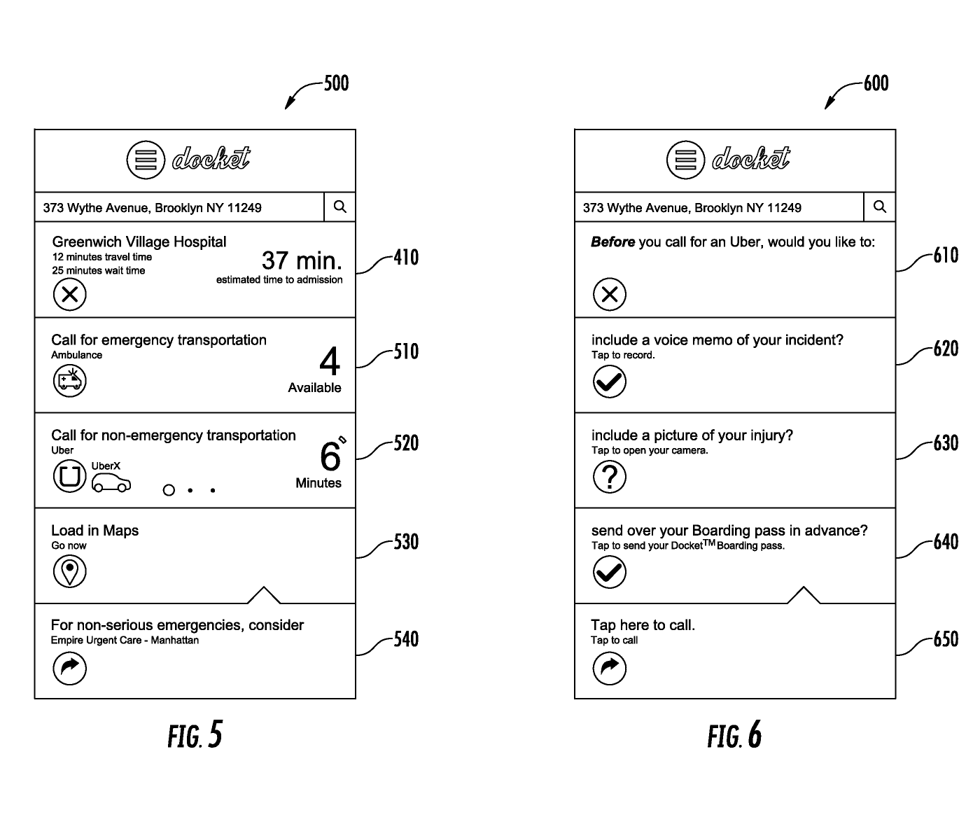

FIG. 4 is a screenshot of a list of emergency departments (or healthcare facilities) in proximity to the user and prioritized according to a combination of estimated travel time and estimated wait time, in accordance with embodiments of the present disclosure.

Screenshot 400 appears when the user selected the “Emergency” icon 220 of FIG. 2. Screenshot 400 depicts a list of emergency departments within proximity to the user. The first emergency department 410 is noted to have a 37 min estimated time to admission. The second emergency department 420 is noted to have a 40 min estimated time to admission. The third emergency department 430 is noted to have a 45 min estimated time to admission. The fourth emergency department 440 is noted to have a 55 min estimated time to admission. Thus, the emergency departments are prioritized in a list format in accordance with the estimated time to admission. The estimated time to admission is calculated or computed based on a combination of average travel time (including traffic conditions) and average wait time at the healthcare facility. Additionally, the travel time and wait time at each emergency department is provided to the user, as noted to the left of each row indicating an emergency department. The current average wait time may be sourced from nearby health systems.

The screenshot 400 may also include the current location 405 of the user. The current location 405 may be edited by the user. The screenshot 400 may also include an interactive map 407 that maps the first, second, third, and fourth emergency departments 410, 420, 430, 440.

Thus, in summary, Docket™ identifies nearby emergency departments that should expect to admit the patient fastest. This intelligent emergency department display feature provides users with a location-based directory of nearby emergency departments. Emergency departments are numerically listed and prioritized according to their combined estimated travel times (based on the patient's distance to each emergency department and current road traffic conditions) as well as the estimated current average wait times for each emergency department listed.

For example, an emergency department A is estimated to be 20 minutes away by car from the user and is currently posting a 20-minute current average wait time. In contrast, an emergency department B is estimated to be 5 minutes away by car from the user and is currently posting a 30-minute current average wait time. Docket's intelligent emergency department display feature prioritizes emergency department B ahead of emergency department A. In this scenario, Docket™ informs the patient that he/she should expect to receive care faster if he/she were to travel to emergency department B instead of emergency department A.

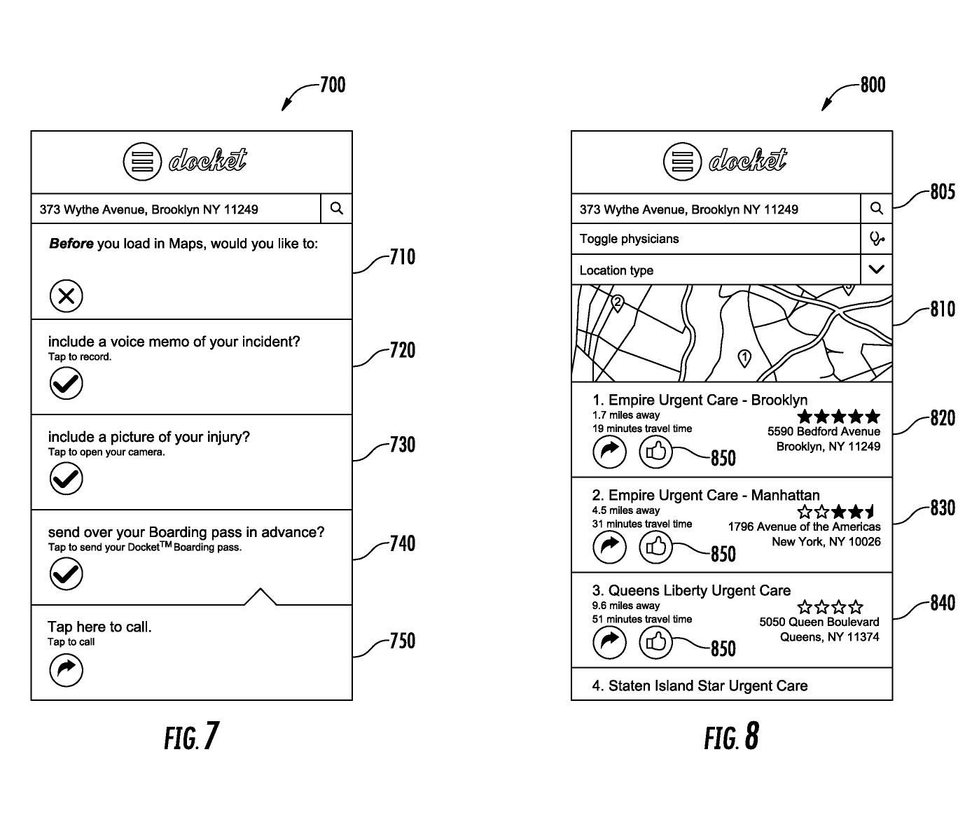

FIG. 5 is a screenshot illustrating selection of an emergency department in FIG. 4, as well as transportation options available to the selected emergency department, in accordance with embodiments of the present disclosure.

Screenshot 500 appears when the user selects the first emergency department 410 of FIG. 4. The first emergency department 410 is displayed in screenshot 500. The user is also presented with emergency transportation options 510 and non-emergency transportation options 520. Emergency transportation options 510 may refer to an ambulance, whereas non-emergency transportation options 520 may refer to mobile ride hail companies, such as taxis or Uber®. The emergency transportation options 510 may even list the number of ambulances available (e.g., 4 in this case). The non-emergency transportation options 520 may list the time it will take for such transportation to arrive at the user's location (e.g., 6 min in this case). Therefore, multiple transportation options are integrated into the healthcare application.

The screenshot 500 may also include a maps feature 530. The maps feature 530 may transmit the “Apple Health Medical ID” to the selected or targeted healthcare organization if the call was placed from the user's mobile device. The healthcare information/data is stored in a database of a server in an encrypted format. When the healthcare information is transmitted to the healthcare or medical facility, the server unencrypts the information/data and sends over an encrypted communication link to the healthcare or medical facility. The screenshot 500 may also include a non-serious emergency feature 540. If the user's situation is not an emergency, then the user may bypass the emergency department 410 and instead be presented with options of urgent care centers. Such urgent care centers may better treat non-emergency situations, as well as provide lower cost options. Therefore, this feature can be considered a decision support alert. In other words, this feature provides the user with further options for making a better decision as to what healthcare facility to seek. As a result, the healthcare application can automatically suggest alternative healthcare facilities for patient treatment.

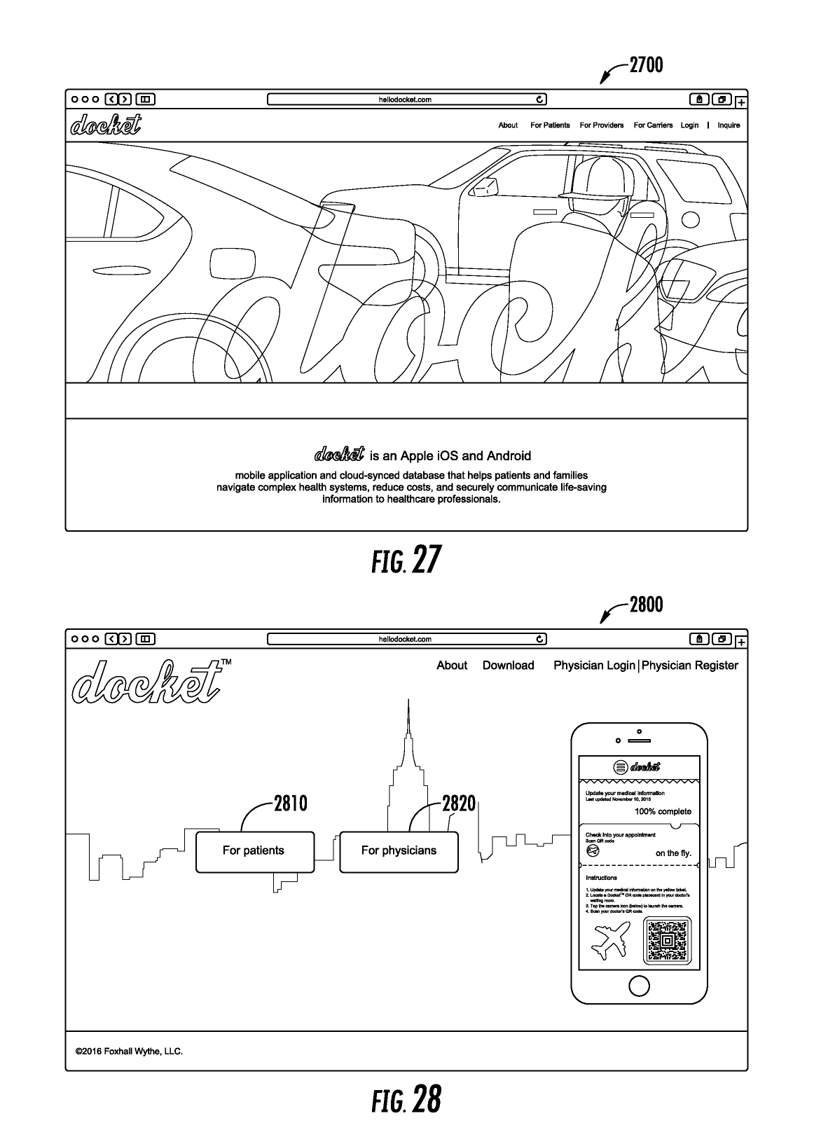

Additionally, the mobile application may alert the emergency department or urgent care center of a potential increase in patient volume based on the following actions taken by the user: 1) calling for an ambulance, 2) calling for non-emergency transportation (such as Uber®), or 3) loading the care facility's location in Apple Maps and/or Google Maps. Thus, Docket™ automatically transmits information stored within the Boarding pass feature (described below in detail) to a web portal accessible to healthcare professionals (see FIGS. 27-30) at whichever care facility the patient indicates he or she intends to visit. This is accomplished when the user takes action through Docket™ by 1) calling for an ambulance, 2) calling for non-emergency transportation (such as Uber®), or 3) loading the care facility's location in Apple Maps and/or Google Maps. In these scenarios, healthcare professionals receive important demographic and/or clinical information prior to the patient's arrival.

Moreover, as noted above, the healthcare information/data is stored in a database of a server in an encrypted format. When the healthcare information is transmitted to the healthcare or medical facility, the server unencrypts the information/data and sends over an encrypted communication link to the healthcare or medical facility. Therefore, the information/data is not being intercepted.

Therefore, Docket™ tracks incoming patient traffic to care facilities over time in order to predict increases in patient volume. If, for instance, Docket™ identifies an increase of patients traveling to emergency department A within a certain timeframe, Docket™ alerts healthcare professionals at emergency department A through a secure web portal (see FIGS. 27-30). These alerts help healthcare professionals anticipate future increases in patient admissions.

FIG. 6 is a screenshot allowing the user to transmit additional information to the selected emergency department before selecting transportation options, in accordance with embodiments of the present disclosure.

Screenshot 600 appears before a transportation selection is made in FIG. 5. Docket™ allows the user to send over important information to the selected or target healthcare facility when the user indicates that he/she is en route. These actions may be triggered each time the user selects a specific transportation option (emergency or non-emergency) or when the maps feature 530 of FIG. 5 is selected. Screenshot 600 depicts a question area 610 where the healthcare application asks “Before you call [transportation option], would you like to.” In section 620, the user is asked whether he/she wants to include a voice message regarding the incident/injury. The voice message may indicate the patient's current condition and/or current primary medical complaint. In section 630, the user is asked whether he/she wants to include one or more pictures or videos of the injury. In section 640, the user is asked whether he/she wants to transmit the “Boarding pass” in advance. In other words, whether the user wants to transmit personal information and/or medical history information to the selected or targeted healthcare facility before arrival to provide the healthcare professionals with time to review the medical history information and make quicker evaluations or determinations before arrival of the user/patient. The medical professionals at the selected or targeted healthcare facility may access this personal and medical history information via the web portal (see FIGS. 27-30). In section 650, the user may directly call the selected or targeted healthcare facility.

Once a patient indicates he or she is en route to a care facility via the Docket™ mHealth application, the patient may choose to a) record a voice memo that summarizes his or her current condition, b) capture a picture and/or video of his or her injury, or c) transmit information recorded in his or her Boarding pass. This information is accessible to a care provider at the facility the patient intends to visit prior to the patient's arrival. If, for example, the patient arrives unresponsive, healthcare professionals have access to the patient's critical medical information. Users also have the ability to identify loved ones (emergency contacts) who will receive notifications indicating that the user is en route to a care facility based on the actions listed above [by 1) calling for an ambulance, 2) calling for non-emergency transportation (such as Uber), or 3) loading the care facility's location in Apple Maps and/or Google Maps]. Patients may also specify emergency contacts to automatically alert if that patient were to indicate he or she is en route to a certain care facility via the Docket™ mobile application.

For instance, patient A indicates that mother A is his emergency contact within the Docket™ mobile application. Patient A then indicates he is en route to emergency department X. Mother A is automatically alerted that patient A is en route to emergency department X. Therefore, a 3^{rd} party (e.g., a relative or loved one) may be automatically contacted upon one or more selections made by the user via the mobile healthcare application.

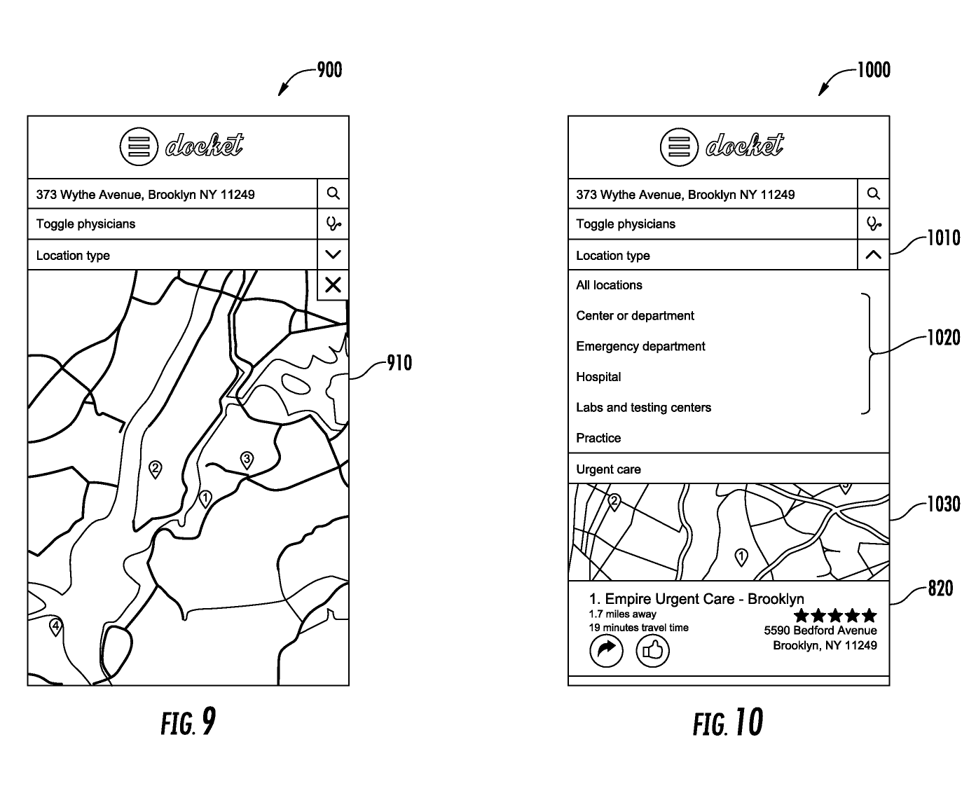

FIG. 7 is a screenshot allowing the user to transmit additional information to the selected emergency department before mapping the selected emergency department, in accordance with embodiments of the present disclosure.

Similar to screenshot 600 of FIG. 6, screenshot 700 appears before the maps feature 530 is selected in FIG. 5. Docket™ allows the user to send over important information to the selected or target healthcare facility when the user indicates that he/she is en route.

Screenshot 700 depicts a question area 710 where the healthcare application asks “Before you load in Maps, would you like to.” In section 720, the user is asked whether he/she wants to include a voice message of the incident/injury. The voice message may indicate the patient's current condition and/or current primary medical complaint. In section 730, the user is asked whether he/she wants to include one or more pictures or videos of the injury. In section 740, the user is asked whether he/she wants to transmit the “Boarding pass” in advance. In other words, whether the user wants to transmit personal information and medical history information to the selected or target healthcare facility before arrival to provide the healthcare professionals with time to review the medical history information and make quicker evaluations or determinations before arrival of the user/patient. The medical professionals at the selected or target healthcare facility may access this personal and medical history information via the web portal (see FIGS. 27-30). In section 750, the user may place a direct call to the selected or target healthcare facility.

FIG. 8 is a screenshot listing urgent care centers available for non-emergency situations, in accordance with embodiments of the present disclosure.

Screenshot 800 appears when the non-serious emergency feature 540 of screenshot 500 of FIG. 5 is selected by the user. Screenshot 800 includes the current location 805 of the user. The current location 805 may be edited by the user. The screenshot 800 may also include an interactive map 810 that maps the first, second, and third urgent care centers 820, 830, 840. The urgent care centers 820, 830, 840 are listed in a prioritized manner in accordance with a combination of the estimated travel time (including current traffic conditions) and estimated wait time at the urgent care centers. As illustrated in FIG. 8, the first urgent care center 820 is 1.7 miles away and has a travel time of 19 minutes. The second urgent care center 830 is 4.5 miles away and has a travel time of 31 minutes. The third urgent care center 840 is 9.6 miles away and has a travel time of 51 minutes. Of course, this is an exemplary embodiment and one skilled in the art may contemplate a variety of different urgent care centers with a variety of different estimated travel time and wait times.

The icon 850 associated with each urgent care center 820, 830, 840 is an insurance compatibility icon that indicates whether the user's insurance is accepted at such urgent care center. In the present example, the first, second, and third urgent care centers 820, 830, 840 all accept the insurance of the user, as indicated by the “thumbs up” illustration of the insurance compatibility icon 850. An icon 850 may be included in any screenshot of the exemplary embodiments of the present disclosure and is not limited only to screenshot 800 of FIG. 8.

Therefore, whenever a patient selects a nearby emergency department, Docket™ has the ability to suggest alterative nearby urgent care centers from which the user could likely expect to be seen by a physician faster and at lower cost. Docket™ compiles geographic information as well as the operating hours and current availability of nearby urgent care centers to dynamically generate alerts that help patients make better decisions about where to receive healthcare.

For example, the user might select emergency department A. Docket™ acknowledges that urgent care center C is located within close proximity to emergency department A. In addition, urgent care center C is currently open for business and has immediate availability. Therefore, Docket™ prompts the user with an alert to consider traveling to urgent care center C instead of emergency department A.

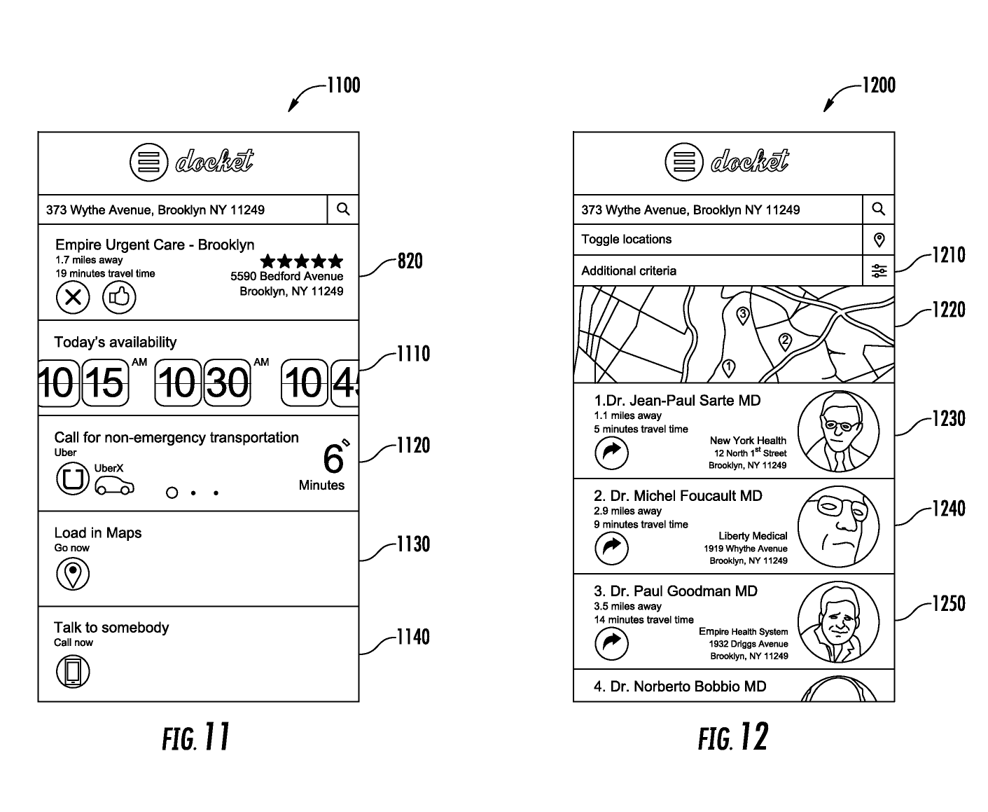

FIG. 9 is a screenshot illustrating a map of the urgent care centers within a proximity of the user, in accordance with embodiments of the present disclosure.

Screenshot 900 appears when the user selects the interactive map 810 of screenshot 800 of FIG. 8. The interactive map 810 is enlarged by the user to an expanded view 910 clearly depicting the location of the first, second, and third urgent care centers 820, 830, 840 with respect to the location of the user.

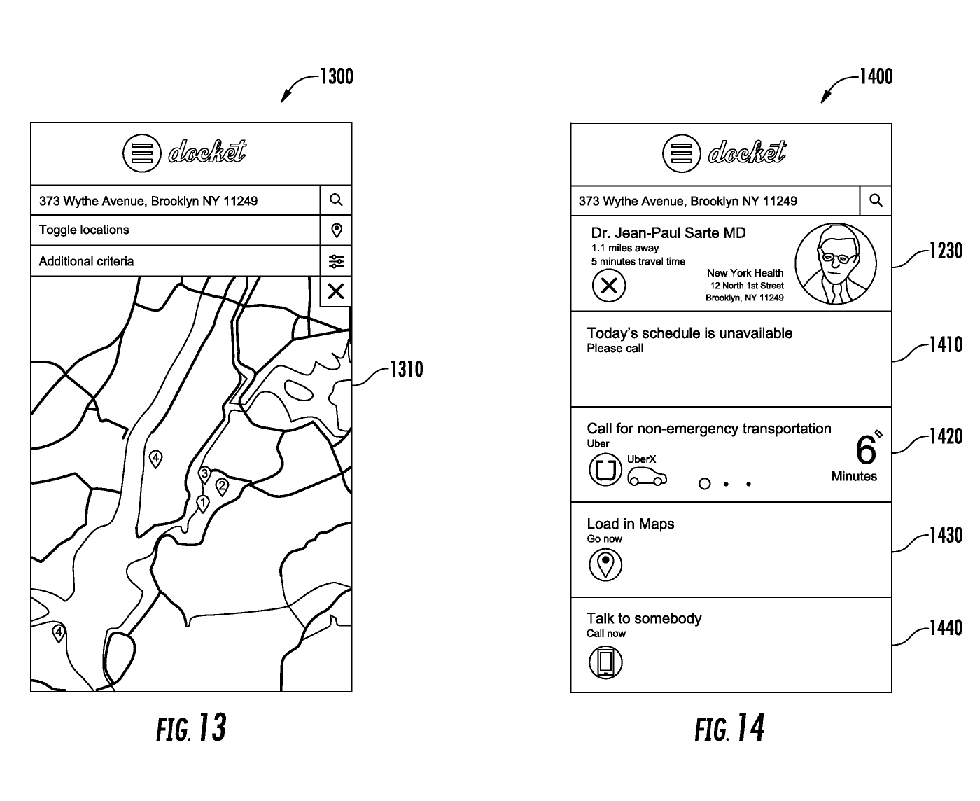

FIG. 10 is a screenshot illustrating options for a location drop-down menu, in accordance with embodiments of the present disclosure.

Screenshot 1000 includes a location type filter 1010, that, when selected, provides a drop-down menu 1020. The drop-down menu 1020 includes the following options: “All locations,” “Center or department,” “Emergency department,” “Hospital,” “Labs and testing centers,” and “Practice.” The user may then select any of these healthcare facilities. The screenshot 1000 also includes an interactive map 1030 of the selected healthcare facility (e.g., urgent care center 820 of screenshot 800 of FIG. 8).

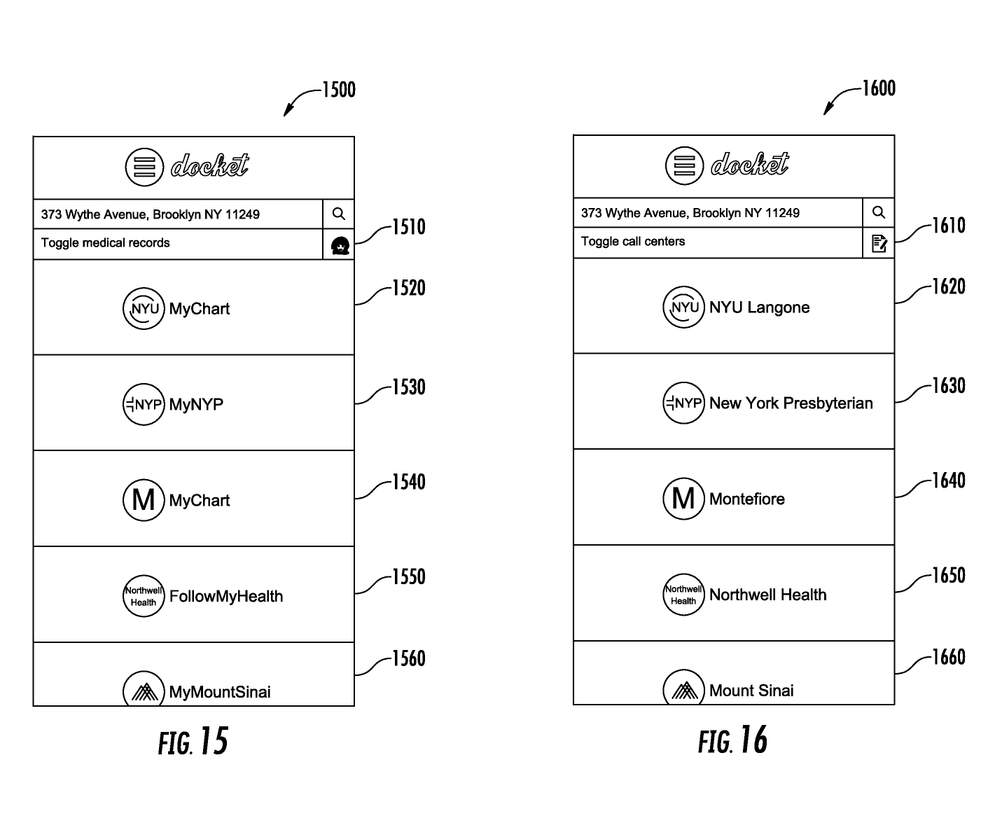

Therefore, Docket™ allows patients to search for nearby care facilities (e.g., centers or departments, emergency departments, hospitals, labs and testing centers, physician practices, and urgent care facilities). Care facility searches may be filtered based on a number of criteria (including, but not limited to, distance from patient's current location, hours of operation, insurance compatibility, and user ratings). Docket™ displays physician availability to assist with scheduling (see FIG. 12). In addition, Docket™ allows patients to schedule appointments directly from the mHealth application, as described below with reference to FIG. 11.

FIG. 11 is a screenshot illustrating availability for a selected urgent care center, in accordance with embodiments of the present disclosure.

Screenshot 1100 appears when the user selects the urgent care center 820 of screenshot 800 of FIG. 8. The screenshot 1100 depicts the availability 1110 of the urgent care center 820. In other words, a user may make an appointment at a specific time by scrolling left to right or right to left through the image carousel. In section 1120, the user may select a non-emergency transportation option. In section 1130, a maps feature 1130 is presented. In section 1140, a call feature is presented where the user may call and talk to a healthcare professional at the selected urgent care center. Therefore, if an urgent care center is selected, the mobile application automatically extracts data pertaining to the urgent care center and provides it, instantly and in real-time, to the user.

FIG. 12 is a screenshot illustrating a list of physicians, in accordance with embodiments of the present disclosure.

Screenshot 1200 filters the results by physician criteria. Thus, the user may select a healthcare facility based on a preferred physician (e.g., specializing in a specific field). The physician criteria may include, but is not limited to, health system affiliation, insurance compatibility, gender, spoken language(s), etc.

Screenshot 1200 depicts an “Additional criteria” type filter 1210 that allows the user to filter the results by preferred physician. In section 1230, a first physician is displayed, in section 1240, a second physician is displayed, and in section 1250, a third physician is displayed. As illustrated in FIG. 12, the first physician 1230 is 1.1 miles away and has a travel time of 5 minutes. The second physician 1240 is 2.9 miles away and has a travel time of 9 minutes. The third physician 1250 is 3.5 miles away and has a travel time of 14 minutes. Of course, this is an exemplary embodiment and one skilled in the art may contemplate a variety of different physicians with a variety of different estimated travel time and wait times. A name, picture, credentials, and affiliation of the physician may also be displayed. Moreover, the address, distance, and travel time to each physician may also be displayed. One skilled in the art may contemplate displaying any type of information related to the physician to aid the patient in making the best decision.

Additionally, the screenshot 1200 provides an interactive map 1220 pinpointing the location of each physician in the list of physicians. Therefore, a user can visually see the location of each physician with respect to his/her location.

FIG. 13 is a screenshot illustrating a map of the location of the physicians listed in the screenshot of FIG. 12, in accordance with embodiments of the present disclosure.

Screenshot 1300 appears when the user selects the interactive map 1220 of screenshot 1200 of FIG. 12. The interactive map 1220 is shown in an expanded view 1310 to clearly illustrate the location of all the physicians 1230, 1240, 1250 listed and prioritized in the screenshot 1200 of FIG. 12.

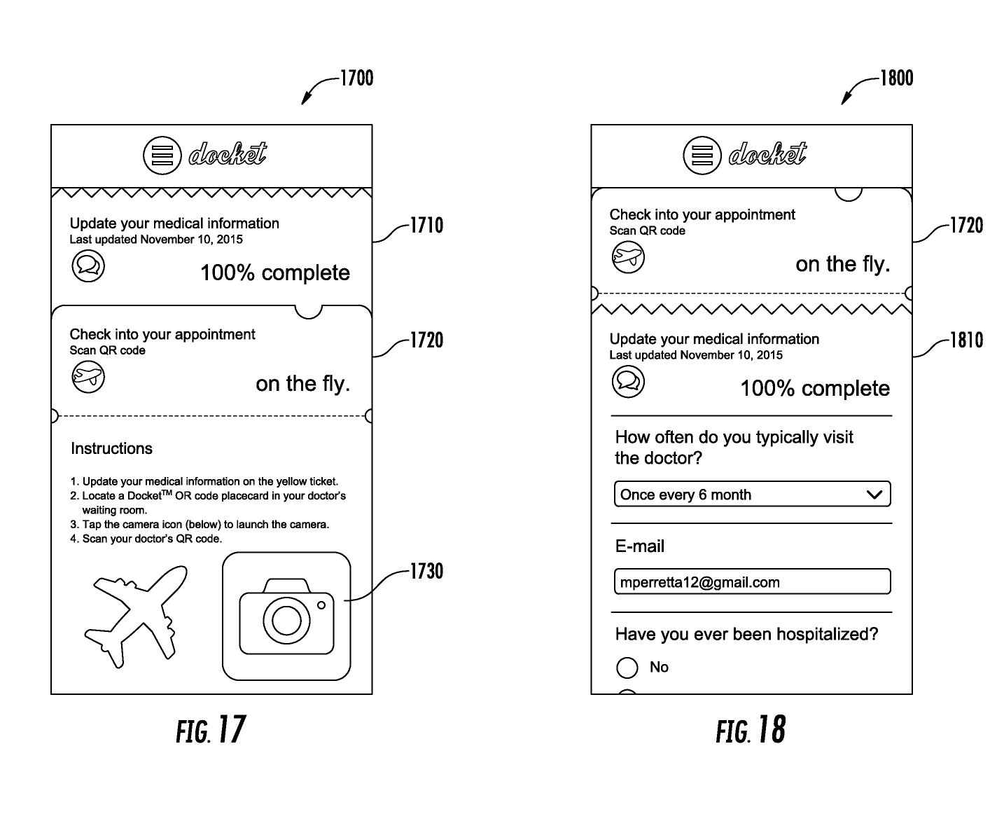

FIG. 14 is a screenshot illustrating a schedule of a selected physician, in accordance with embodiments of the present disclosure.

Screenshot 1400 appears when the user selects the first physician 1230 listed and prioritized in the screenshot 1200 of FIG. 12. In section 1410, the schedule of the first physician 1230 is displayed. It is shown as unavailable. In section 1420, transportation options are provided to the user if the user desires to visit the first physician 1230. In section 1430, a maps feature is presented to the user to map the location of the first physician 1230. In section 1440, the user is permitted to call the first physician 1230. Therefore, the screenshot 1400 integrates the schedule and/or availability of the first physician 1230. Additionally, the user is permitted, in various stages of using the healthcare application, to transmit important personal information and medical history information to either the healthcare facility selected or targeted or to the selected or targeted physician directly.

Thus, the healthcare application allows for direct communication between the user/patient and/or the healthcare facility and/or physician selected or targeted. In one instance, the direct communication may occur automatically. In another instance, the direct communication may be triggered manually by the patient (i.e., pressing a button or making a selection via the healthcare application). In yet another instance, the direct communication may occur when the user/patient indicates that he/she is en route to the healthcare facility and/or physician. The direct communication may occur at various stages of using the healthcare application. For example, direct communication may occur when a transportation option has been selected by the user.

Moreover, in the exemplary embodiments of the present disclosure, the healthcare application may automatically alert the healthcare facility (e.g., emergency department or urgent care center) and/or the physician of a potential increase in patient volume based on a number of factors, including, but not limited to selection of transportations options, as well as selecting the maps feature in various stages of using the healthcare application. This feature may be referred to as predictive analytics, as the healthcare application can predict an increase in a volume of patients headed over to various healthcare facilities and/or physicians.

FIG. 15 is a screenshot of a list of medical records of the user from different medical facilities that are accessed by the healthcare application, in accordance with embodiments of the present disclosure.

Screenshot 1500 may include a feature to connect the healthcare application with/to existing medical records. Thus, the healthcare application may connect or access information from one or more call centers that have medical records of the patient/user (see FIG. 16). In section 1510, a user may select the “Toggle medical records” option, which provides a drop-down menu with various existing medical records. In section 1520, the “MyChart” personal healthcare record may be accessed and transmitted to the selected or targeted healthcare facility. In section 1530, the “MyNYP” personal healthcare record may be accessed and transmitted to the selected or targeted healthcare facility. In section 1540, the “MyChart” personal healthcare record may be accessed and transmitted to the selected or targeted healthcare facility. In section 1550, the “FollowMyHealth” personal healthcare record may be accessed and transmitted to the selected or targeted healthcare facility. In section 1560, the “MyMountSinai” personal healthcare record may be accessed and transmitted to the selected or targeted healthcare facility. Thus, the healthcare application may be given permission to access personal information and medical record information of the user/patient, and the healthcare application may then transmit such information to the selected or targeted healthcare facility.

FIG. 16 is a screenshot of a list of different call centers handling associated medical records of the user that are accessed by the healthcare application, in accordance with embodiments of the present disclosure.

Screenshot 1600 may include a feature to connect with call centers. Thus, the healthcare application may connect or access information from one or more call centers that have medical records of the patient/user. In section 1610, a user may select the “Toggle call centers” option, which provides a drop-down menu with various call centers. In section 1620, the “NYU Langone” call center may be contacted to access records and transmit those records to the selected or targeted healthcare facility. In section 1630, the “New York Presbyterian” call center may be contacted to access records and transmit those records to the selected or targeted healthcare facility. In section 1640, the “Montefiore” call center may be contacted to access records and transmit those records to the selected or targeted healthcare facility. In section 1650, the “Northwell Health” call center may be contacted to access records and transmit those records to the selected or targeted healthcare facility. In section 1660, the “Mount Sinai” call center may be contacted to access records and transmit those records to the selected or targeted healthcare facility. Thus, the healthcare application may be given permission to contact call centers (i.e., hospitals, urgent care centers, etc.) to access personal information and medical record information of the user/patient, and the healthcare application may then transmit such information to the selected or targeted healthcare facility. Thus, any pre-existing medical records located at one or more medical or healthcare facilities may be accessed by the healthcare application of the present disclosure and transmitted to a healthcare facility about to be visited by the user. Moreover, the call centers may be listed and prioritized according to proximity to the user. The proximity may be set by the user.

FIG. 17 is a screenshot prompting the user to update medical information, in accordance with embodiments of the present disclosure.

Screenshot 1700 relates to the “Boarding pass” feature of the exemplary embodiments of the present disclosure. Concerning the patient check-in feature, the Docket™ Boarding pass feature (“Boarding pass”) allows patients to consolidate personal demographic and insurance coverage information in order to assist in patient registration and admission workflows within a healthcare setting. Furthermore, Boarding pass allows patients to disclose various types of information through the use of consolidated medical history and health assessment questionnaires. Information pertaining to patients' medical histories, chief medical complaints, diet and exercise routines, behavioral health, sexual wellness, and drug and alcohol consumption patterns is consolidated and maintained within Boarding pass. Docket™ automatically reminds patients to update the information stored within Boarding pass on a periodic basis (based on how often the patient indicates he or she typically seeks healthcare). Additionally, Boarding pass aggregates patient-entered information as well as data sourced from Apple's HealthKit as well as various wearable fitness devices and personal health record (PHR) portals.

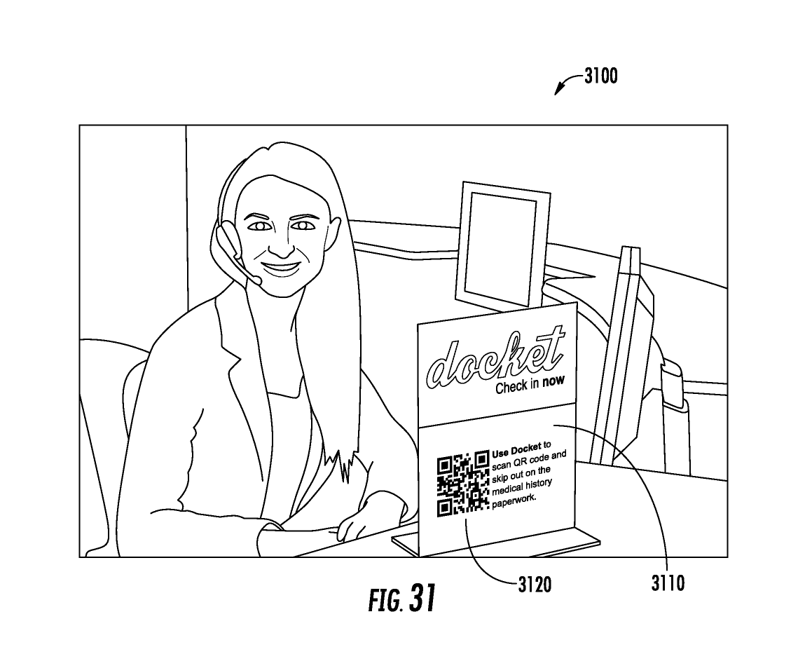

Screenshot 1700 includes a section 1710 allowing the user to update medical information. The user may be prompted at predetermined or predefined intervals to update such information. Section 1720 allows the user to check into the appointment at the selected or targeted healthcare facility. The check-in or registration may take place via the camera icon 1730. The camera icon 1730 activates the camera of the mobile device operating the mobile health application. The camera (not shown) of the mobile device captures an image of a Quick response (QR) code located at the healthcare facility (see FIG. 31).

The medical history information is saved on the healthcare application. Thus, the user need not fill out any type of medical history questionnaire at the healthcare facility because such information has already been digitized and stored in a database accessed by the healthcare application. Such digitized medical history information may be easily transmitted to the healthcare facility by engaging a QR code at the healthcare facility (see FIG. 31).

The information stored within the Boarding pass may be sourced from a plurality of sources, such as, but not limited to, patient entered information, fitness trackers, wearable devices, and personal health record (PHR) portals accessed by the healthcare application. Therefore, the healthcare application can connect and directly access data from a variety of sources. The healthcare application may directly communicate with portable electronic devices, such as, but not limited to, fitness trackers and wearable devices. This data may be collected in real-time and on a continuous basis. The healthcare application may directly communicate with call centers of health systems that have stored medical records. This data may be collected in real-time and on a continuous basis. However, this data may also be collected when prompted by the user/patient.

FIG. 18 is a screenshot prompting the user to check into the appointment by engaging a QR code at the healthcare facility, in accordance with embodiments of the present disclosure.

Screenshot 1800 provides an expanded view 1810 of the medical information update section 1720 of FIG. 17. The user has the capability to enter any additional information he/she sees fit just before or while checking into the selected or targeted healthcare facility.

FIG. 19 is a screenshot illustrating information to be entered by the user to update medical information, in accordance with embodiments of the present disclosure.

Screenshot 1900 provides a scroll-down menu 1910 for scrolling through the questions of the medical history questionnaire. The user may scroll down to, for example, enter additional medical information.

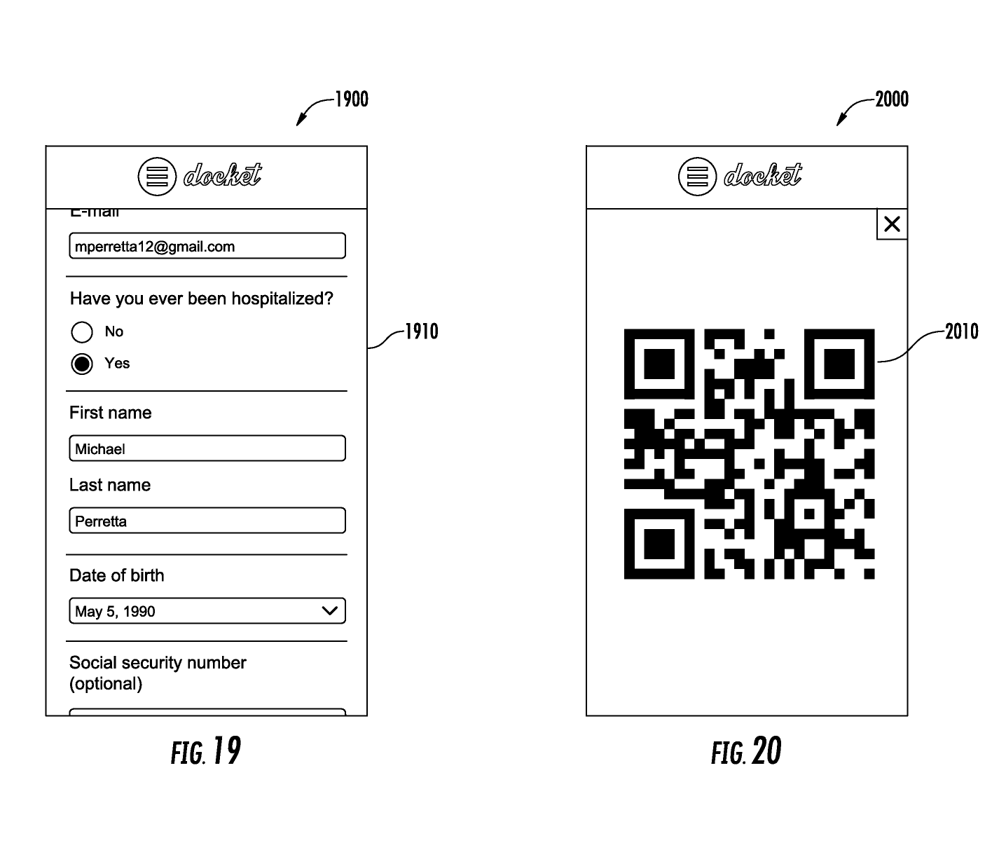

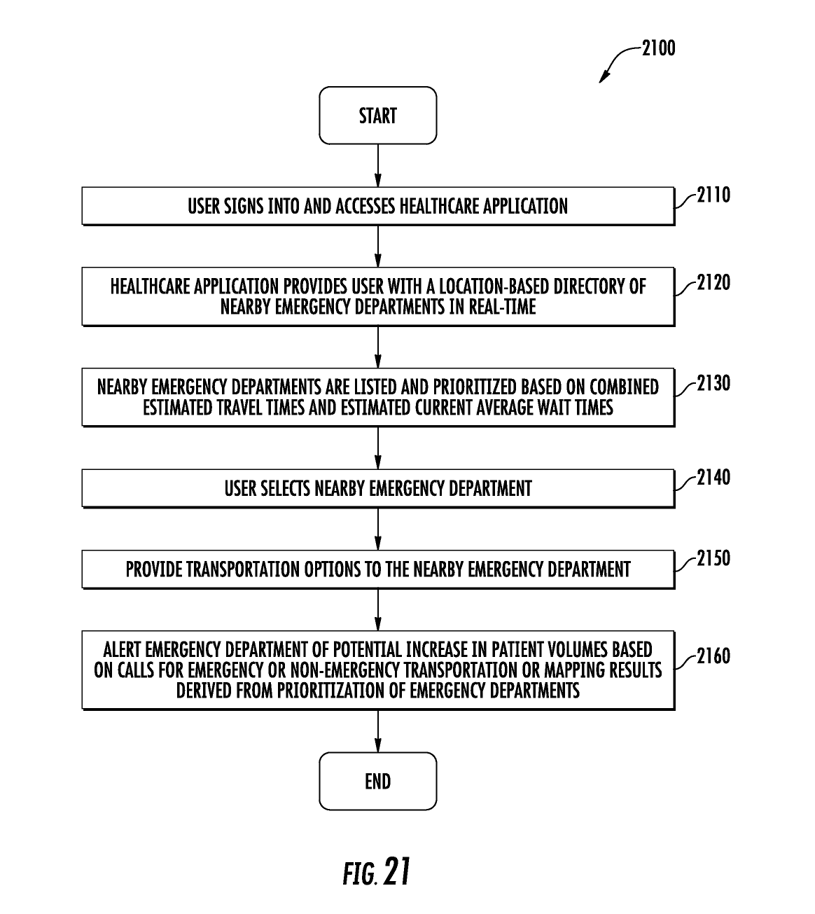

FIG. 20 is a screenshot illustrating the QR code captured by the camera of the mobile device of the user at the healthcare facility, in accordance with embodiments of the present disclosure.

The screenshot 2000 illustrates that the user captured the QR code 2010 located at the healthcare facility via the camera icon 1730 shown in screenshot 1700 of FIG. 17. The QR code may be posted in the healthcare facility. For example, it may be posted at the entrance or the reception area of the healthcare facility. Of course, the QR code may be posted anywhere within or outside the facility. It is contemplated that the ambulance of an emergency department may also include a QR code to be scanned by the user/patient. As a result, such information may be transferred to first responders as well. By engaging the QR code, the user of the healthcare application can automatically transfer medical history information to the healthcare facility in a digital manner, without the need for filling out the lengthy medical history questionnaire. As such, the medical personnel or professionals at the healthcare facility can instantly access the medical history information of the patient/user of the mobile healthcare application. The information may be accessed through the web portal, discussed in detail below with reference to FIGS. 27-30.

Additionally, with reference to the exemplary embodiments of the present disclosure, a periodic feed of health news may be enabled by the healthcare application. Thus, the user may select an option to receive health news feeds regarding various topics that the user is interested in. The news feed may be provided by one or more advertisers or sponsors. Therefore, the costs associated with running this healthcare application may be offset by advertising dollars.

FIG. 21 is a flowchart describing the selection of an emergency department, in accordance with embodiments of the present disclosure.

The flowchart 2100 includes the following steps. In step 2110, a user (or patient) signs into and accesses healthcare application. In step 2120, the healthcare application provides the user with a location-based directory of nearby emergency departments in real-time. In step 2130, nearby emergency departments are listed and prioritized based on combined estimated travel times and estimated current average wait times. In step 2140, the user selects a nearby emergency department. In step 2150, the healthcare application provides transportation options to the nearby emergency department. In step 2160, the healthcare application alerts the emergency department of a potential increase in patient volumes based on calls for emergency or non-emergency transportation or mapping results derived from prioritization of emergency departments.

The process then ends. It is to be understood that the method steps described herein need not necessarily be performed in the order as described. Further, words such as “thereafter,” “then,” “next,” etc., are not intended to limit the order of the steps. These words are simply used to guide the reader through the description of the method steps.

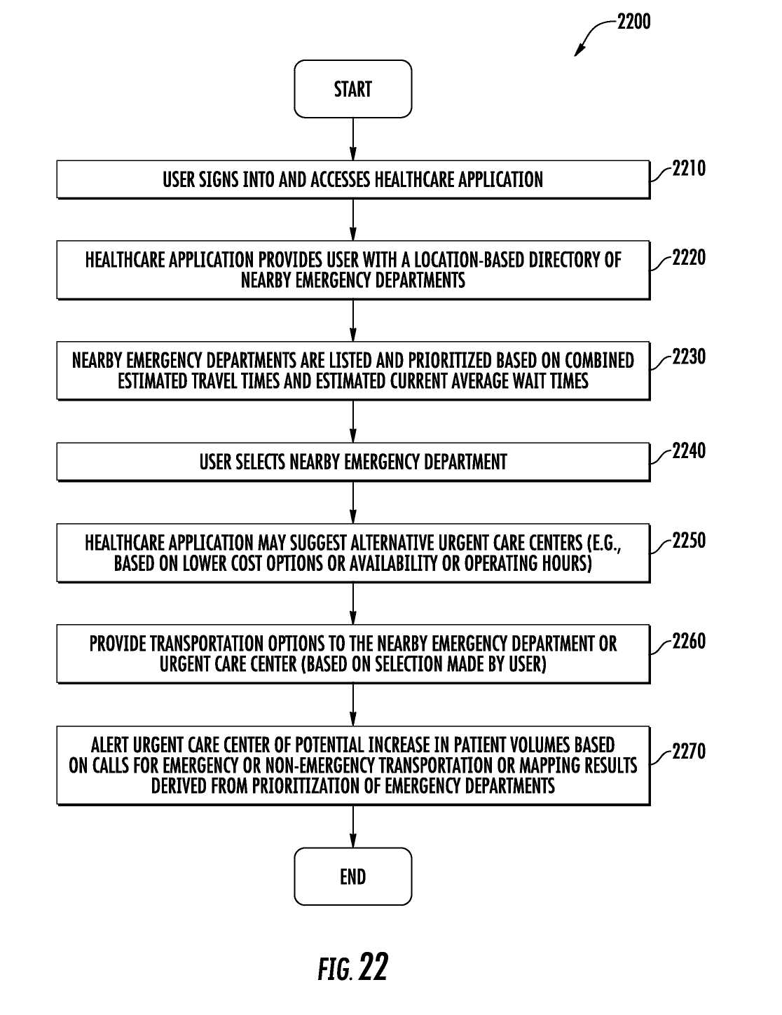

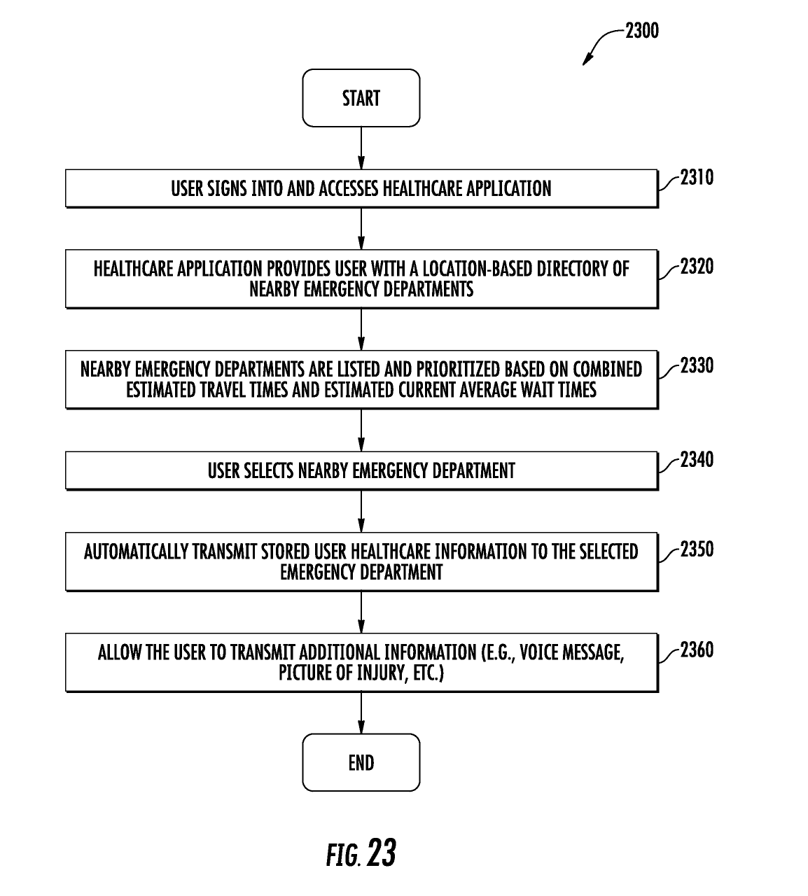

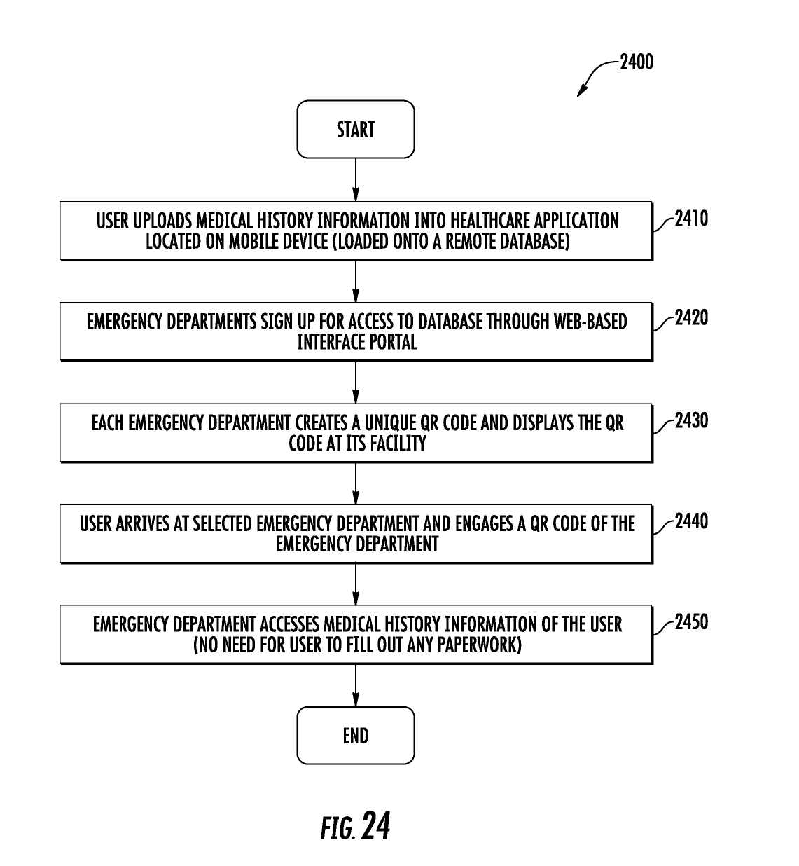

FIG. 22 is a flowchart describing the mobile application suggesting alternative urgent care centers for the user, in accordance with embodiments of the present disclosure.

The flowchart 2200 includes the following steps. In step 2210, a user (or patient) signs into and accesses healthcare application. In step 2220, the healthcare application provides the user with a location-based directory of nearby emergency departments in real-time. In step 2230, nearby emergency departments are listed and prioritized based on combined estimated travel times and estimated current average wait times. In step 2240, the user selects a nearby emergency department. In step 2250, the healthcare application may suggest alternative urgent care centers (e.g., based on lower cost options or availability or operating hours). In step 2260, the healthcare application provides transportation options to the nearby emergency department. In step 2270, the healthcare application alerts the emergency department of a potential increase in patient volumes based on calls for emergency or non-emergency transportation or mapping results derived from prioritization of emergency departments.

The process then ends. It is to be understood that the method steps described herein need not necessarily be performed in the order as described. Further, words such as “thereafter,” “then,” “next,” etc., are not intended to limit the order of the steps. These words are simply used to guide the reader through the description of the method steps.

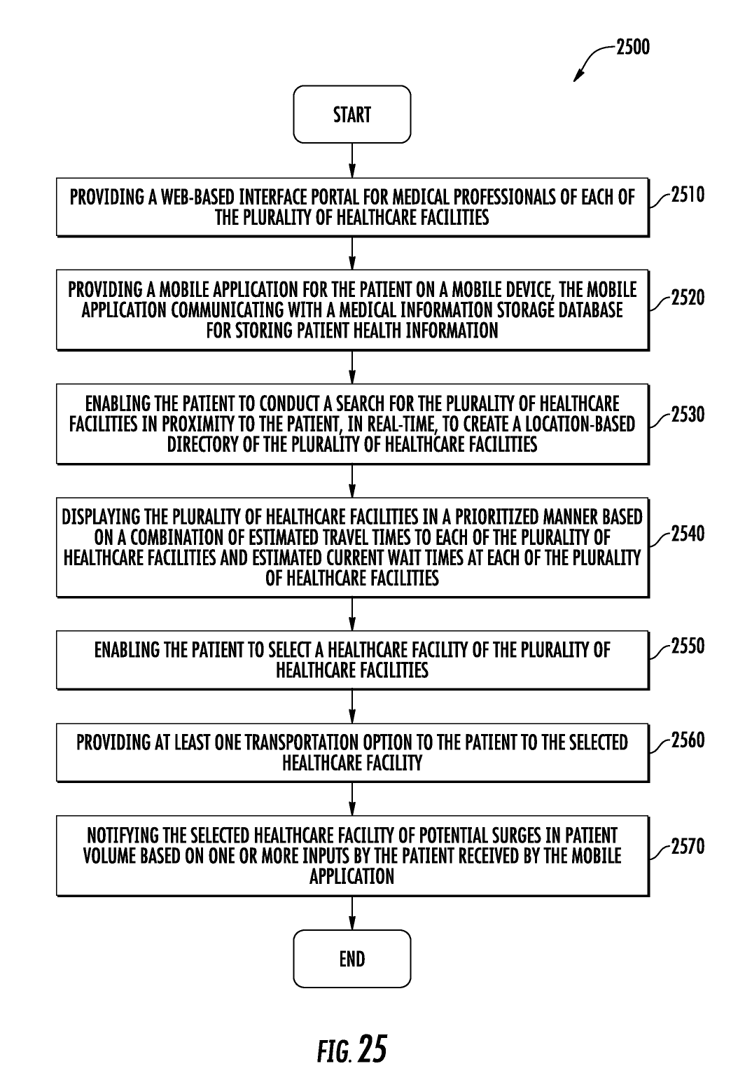

FIG. 23 is a flowchart describing the mobile application automatically transmitting stored user healthcare information to a selected healthcare facility, in accordance with embodiments of the present disclosure.

The flowchart 2300 includes the following steps. In step 2310, a user (or patient) signs into and accesses healthcare application. In step 2320, the healthcare application provides the user with a location-based directory of nearby emergency departments in real-time. In step 2330, nearby emergency departments are listed and prioritized based on combined estimated travel times and estimated current average wait times. In step 2340, the user selects a nearby emergency department. In step 2350, the healthcare application automatically transmits stored user healthcare information to the selected emergency department. In step 2360, the user is permitted to transmit additional information (e.g., voice message, picture of injury, etc.).

The process then ends. It is to be understood that the method steps described herein need not necessarily be performed in the order as described. Further, words such as “thereafter,” “then,” “next,” etc., are not intended to limit the order of the steps. These words are simply used to guide the reader through the description of the method steps.

FIG. 24 is a flowchart describing engagement between the user and the QR code at the healthcare facility selected by the user, in accordance with embodiments of the present disclosure.

The flowchart 2400 includes the following steps. In step 2410, the user uploads medical history information into the healthcare application located on mobile device (loaded onto a remote database). In step 2420, emergency departments sign up for access to database through web-based interface portal. In step 2430, each emergency department creates a unique QR code and displays the QR code at its facility. In step 2440, the user arrives at the selected emergency department and engages a QR code of the emergency department. In step 2450, the emergency department accesses medical history information of the user (no need for user to fill out any paperwork).

The process then ends. It is to be understood that the method steps described herein need not necessarily be performed in the order as described. Further, words such as “thereafter,” “then,” “next,” etc., are not intended to limit the order of the steps. These words are simply used to guide the reader through the description of the method steps.

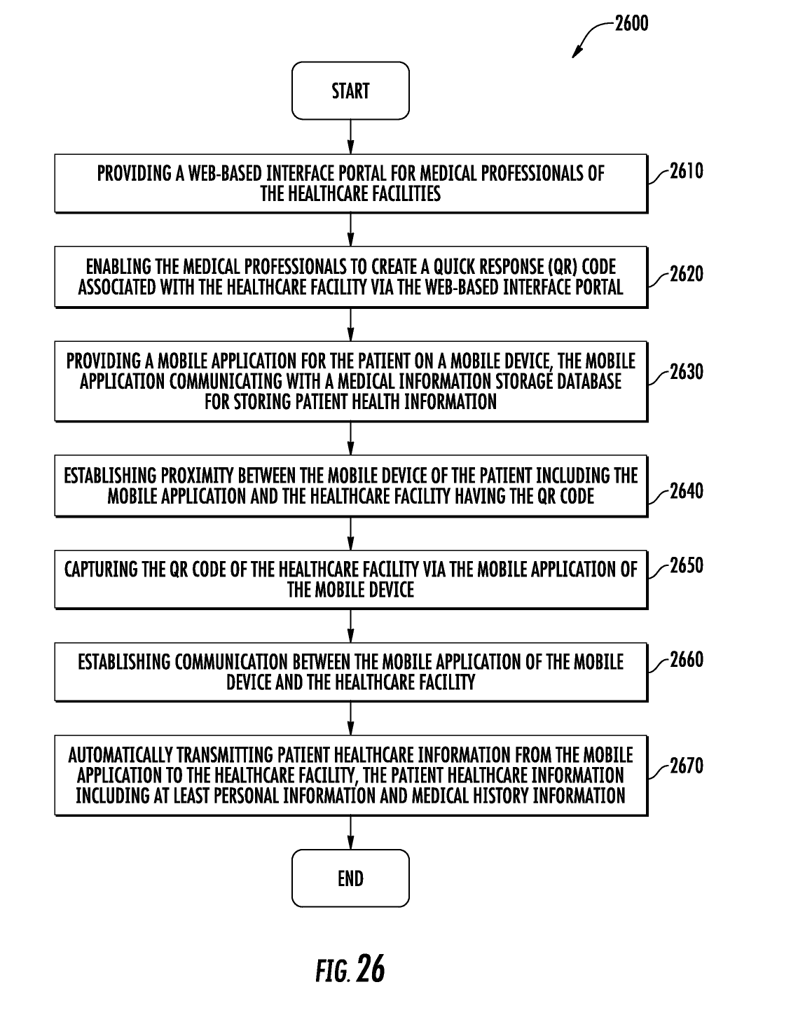

FIG. 25 is a flowchart describing the process of enabling the user to select a healthcare facility and transportation options to the selected healthcare facility, in accordance with embodiments of the present disclosure.

The flowchart 2500 includes the following steps. In step 2510, a web-based interface portal is provided for medical professionals of each of the plurality of healthcare facilities. In step 2520, a mobile application is provided for the patient on a mobile device, the mobile application communicating with a medical information storage database for storing patient health information. In step 2530, the patient conducts a search for the plurality of healthcare facilities in proximity to the patient, in real-time, to create a location-based directory of the plurality of healthcare facilities. In step 2540, the plurality of healthcare facilities are displayed in a prioritized manner based on a combination of estimated travel times to each of the plurality of healthcare facilities and estimated current wait times at each of the plurality of healthcare facilities. In step 2550, the patient selects a healthcare facility of the plurality of healthcare facilities. In step 2560, at least one transportation option is provided to the patient to the selected healthcare facility. In step 2570, the selected healthcare facility is notified of potential surges in patient volume based on one or more inputs by the patient received by the mobile application.

The process then ends. It is to be understood that the method steps described herein need not necessarily be performed in the order as described. Further, words such as “thereafter,” “then,” “next,” etc., are not intended to limit the order of the steps. These words are simply used to guide the reader through the description of the method steps.

FIG. 26 is a flowchart describing the process of checking in at the selected healthcare facility by using the QR code, in accordance with embodiments of the present disclosure.

The flowchart 2600 includes the following steps. In step 2610, a web-based interface portal is provided for medical professionals of the healthcare facility. In step 2620, the medical professionals create a Quick Response (QR) code associated with the healthcare facility via the web-based interface portal. In step 2630, a mobile application is provided for a patient on a mobile device, the mobile application communicating with a medical information storage database for storing patient health information. In step 2640, proximity is established between the mobile device of the patient including the mobile application and the healthcare facility having the QR code. In step 2650, the QR code of the healthcare facility is captured via the mobile application of the mobile device. In step 2660, communication is established between the mobile application of the mobile device and the healthcare facility. In step 2670, patient healthcare information is automatically transmitted from the mobile application to the healthcare facility, the patient healthcare information including at least personal information and medical history information.

The process then ends. It is to be understood that the method steps described herein need not necessarily be performed in the order as described. Further, words such as “thereafter,” “then,” “next,” etc., are not intended to limit the order of the steps. These words are simply used to guide the reader through the description of the method steps.

FIG. 27 is a screenshot of the web-based interface portal, in accordance with embodiments of the present disclosure.

The web-based interface portal 2700 provides information for consumers and information for medical care professionals/healthcare facilities. Medical professionals at healthcare facilities can access the web-based interface portal 2700 to create an account and provide their information so that users of the mobile health application can access their facilities. The web-based interface portal 2700 provides for real-time data delivery to healthcare professionals.

The mobile application on the mobile device may communicate with the web-based interface portal 2700 via one or more servers over a network. The information entered into the mobile application may be stored on a database associated with the one or more servers. The database may be accessed by medical professionals or medical staff that register with the web-based interface portal 2700.

FIG. 28 is a screenshot of the web-based interface portal used by patients and medical professionals at healthcare facilities, in accordance with embodiments of the present disclosure.

The screenshot 2800 indicates a button 2810 for patients and a button 2820 for physicians. If a physician accesses the web-based interface portal 2700 via button 2820, the following functions/operation may be available to the healthcare professional: an emergency department dashboard, emergency department analytics, and arrived patients. The emergency department dashboard may include incoming emergency room traffic, information stored on the user's Apple Medical ID, the number of available ambulances. The emergency department analytics may include emergency room traffic over time across various methods of transportation and alerts for potential increases in incoming patient volumes. The arrived patient feature may include information related to the “Boarding pass” feature and granting access to registration staff of patient medical records through “Boarding pass” when the patient engages the QR code at the healthcare facility.

FIG. 29 is a screenshot of the web-based interface prompting the medical professionals to enter information regarding the healthcare facility, in accordance with embodiments of the present disclosure.

Screenshot 2900 is used by medical professionals at the healthcare facility to enter data 2910 related to the healthcare facility. It provides the healthcare facility with the means to register with the web-based interface portal 2700.

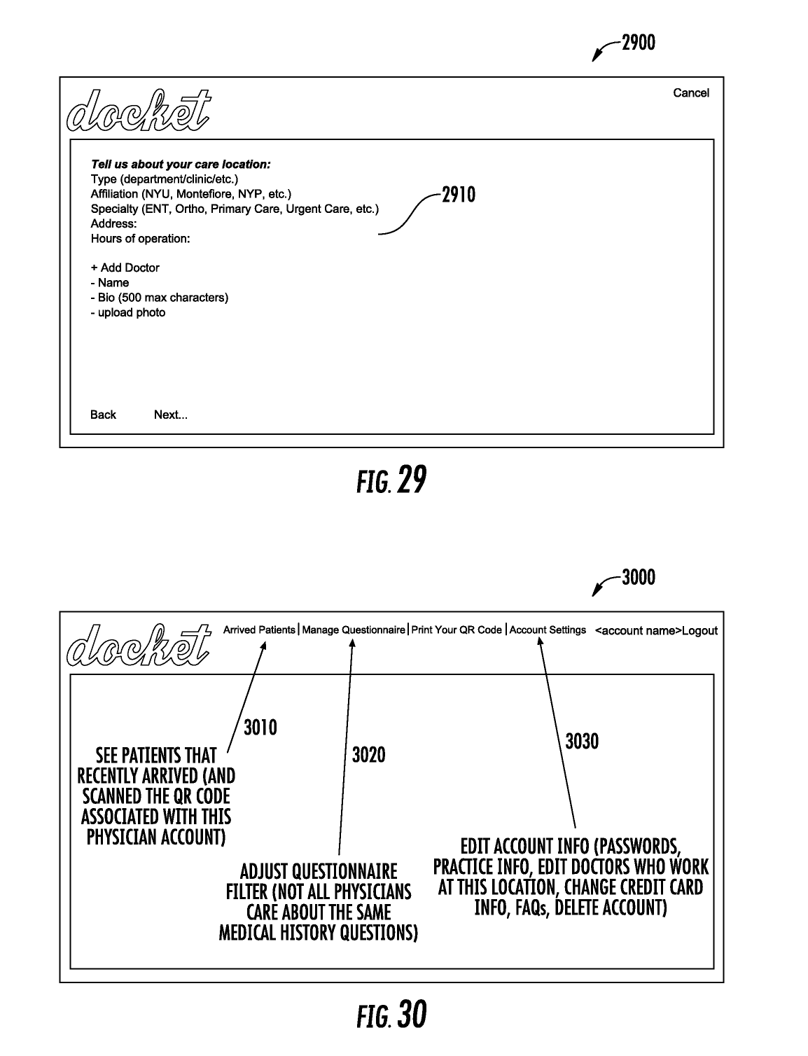

FIG. 30 is a screenshot of the web-based interface including a plurality of links, in accordance with embodiments of the present disclosure.

Screenshot 3000 provides various links for the healthcare professionals at the healthcare facility. For example, the “Arrived patients” link 3010 may list the patients that recently arrived to the healthcare facility and engaged the QR code. The “Manage Questionnaire” link 3020 allows each physician to filter the medical history questionnaire provided to them by the user/patient that checked-in by engaging the QR code. Each physician may be interested in different types of information in order to quickly diagnose and treat the patient/user. Therefore, each physician may filter out or remove any questions the physician feels does not contribute to a quick treatment. Thus, each physician has the power to view data pertinent to his/her expertise. The “Account Settings” link 3030 allows the account information to be edited. Such information may include, but is not limited to, passwords, doctors, practice information, changes in credit card information, deleting an account, FAQs, etc.

FIG. 31 is a QR code displayed at a healthcare facility, the QR code to be engaged by the user when entering the healthcare facility, in accordance with embodiments of the present disclosure.

As noted above, a QR code 3120 is displayed on a display means 3110 at a medical facility 3100. The QR code 3120 may be displayed at the receptionist's desk or at any entrance of the medical facility 3100. When the patient arrives at the medical facility 3100, he/she launches the Docket™ application from his/her mobile device. Specifically, the user accesses the “Boarding pass” feature of the Docket™ application to engage the QR code 3120 at the medical facility 3100. Of course, the patient may also authorize transmission of the content (i.e., medical history information) while en route to the medical facility 3100. Once the user takes a picture of the QR code with the mobile device, the user's medical history information may be accessed by the medical facility 3100 via the web-based interface portal 2700. The medical facility 3100 would have previously accessed the web-based interface portal 2700 to register and add information related to the medical facility 3100. Thus, the user need not fill out any paperwork upon arrival at the medical facility 3100. Instead, all the medical history information of the patient is digitized and automatically transferred to the medical facility 3100 via the mobile application and accessed by the medical facility 3100 via the web-based interface portal 2700. The medical information transferred may also include a “last updated” time stamp. The medical information transferred may also include an identifying photo to verify the patient.

In an alternative embodiment, Docket™ may track and report medication compliance. Docket™ prompts users to enter various types of information, including types of medication used by the user. As a result, based on this entered information, Docket™ may generate medication reminders or alerts or warnings or notifications to users/patients. Thus, patients would be reminded to take their pills and would also be prompted to indicate to Docket™ that they indeed took their pills. Additionally, Docket™ may track and record medication compliance rates. This information may then be sent to one or more third parties, such as doctors or medical facilities. This information may also be transferred when the patient visits a medical facility and scans the QR code at the medical facility. Therefore, upon admittance to the medical facility, the medical professionals at the medical facility may instantly know whether the patient has complied with his/her medication regimen.

Consequently, the presently disclosed subject matter provides a medication adherence system for monitoring a patient's medication adherence and facilitating dose reminder notifications. Further, the exemplary embodiments are adaptive systems that enforce medication compliance based on both local and cloud based intelligence by constantly monitoring the consumption of each medication by a patient. They also provide a reliable cloud based system for specifying medication regimes and schedules. The use of the cloud enables multiple caregivers or medical professionals to monitor the medication compliance of the patient from anywhere and at any time and provides an additional level of enforcement via email, phone, SMS, MMS, and social media contact, all of which are above and beyond the direct enforcement mechanisms the proposed system provides to the patient.

In summary, the Docket™ “Dash” feature helps expedite the patient registration process. Docket™ allows users to store and update a copy of their medical history information. Data elements such as recent hospitalizations, chief medical complaints, and patient demographics are maintained within Docket™. Whenever the user arrives at a care facility with a Docket™ “Dash” placard and QR code posted at the registration and/or receptionist desk, the user has the ability to engage the “Dash” feature. Accordingly, Docket™ allows the user to scan the QR code. This action grants the receptionist and/or registration staff the ability to download and print a copy of the user's medical history information stored within Docket™. The Docket™ “Dash” feature helps the user reduce duplicative paperwork and save time.

In summary, the mobile healthcare application (i.e., Docket™) of the exemplary embodiments of the present disclosure relates to a location-based directory, real-time decision support, and predictive analytics. The location-based directory improves patient access to healthcare facilities. The real-time decision support advises patients on optimal healthcare options, and the predictive analytics alerts healthcare facilities of potential surges in patient volume. The location-based directory provides for intuitive mapping of healthcare providers and locations of healthcare providers, coordinates multiple transportation options for the patient to the healthcare facilities, and improves emergency response time. The real-time decision support advises patients based on current traffic conditions and current wait times, as well as physician/appointment availability, lower cost options, and reviews of each healthcare facility. Thus, Docket™ helps patients identify optimal emergency or urgent care options, coordinates emergency and non-emergency transportation, communicates life-saving information to the healthcare professional, alerts emergency departments of potential surges in volume, and expedites patient's prescreening paperwork.

The benefits of the mobile healthcare application (i.e., Docket™) to the patient are as follows: reduction in paperwork filled out by the patient, improved access to healthcare facilities, and enhancement of patient safety. Improved access is facilitated by providing the user/patient with a multitude of transportation options, as well as lower cost alternatives. For instance, if the incident is not an emergency, the healthcare application suggests or recommends or advises the patient/user to select from a list of non-emergency options (e.g., urgent care centers). Therefore, the user/patient may be redirected from a busy hospital or emergency center to urgent care centers that can handle such injury/incident with a lower cost and within a quicker time frame.

The benefits of the mobile healthcare application (i.e., Docket™) to the providers are as follows: alleviates emergency department congestion by re-directing non-emergency traffic, enhances patient safety, and improves patient satisfaction. Patient safety may be enhanced collecting expected patients' personal information and medical history information beforehand (or as the patient arrives to the healthcare facility), and anticipation in increases in patient volume, which gives medical professionals at healthcare facilities an opportunity to put procedures in place to handle the expected high volume of patients. Therefore, healthcare facilities operate more efficiently.

The benefits of the mobile healthcare application (i.e., Docket™) to the payers are as follows: reduces cost by reducing non-emergency traffic, enhancing patient safety, and filtering healthcare options by filtering for insurance compatibility.

The implementations described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program or computer program). An apparatus may be implemented in, for example, appropriate hardware, software, and firmware. The methods may be implemented in, for example, an apparatus such as, for example, a processor, which refers to processing devices in general, including, for example, a computer, a microprocessor, an integrated circuit, or a programmable logic device. Processors also include communication devices, such as, for example, computers, cell phones, tablets, portable/personal digital assistants, and other devices that facilitate communication of information between end-users within a network.

The general features and aspects of the present disclosure remain generally consistent regardless of the particular purpose. Further, the features and aspects of the present disclosure may be implemented in system in any suitable fashion, e.g., via the hardware and software configuration of system or using any other suitable software, firmware, and/or hardware.

For instance, when implemented via executable instructions, various elements of the present disclosure are in essence the code defining the operations of such various elements. The executable instructions or code may be obtained from a readable medium (e.g., a hard drive media, optical media, EPROM, EEPROM, tape media, cartridge media, flash memory, ROM, memory stick, and/or the like) or communicated via a data signal from a communication medium (e.g., the Internet). In fact, readable media may include any medium that may store or transfer information.

According to one embodiment of the present disclosure, the components, process steps, and/or data structures disclosed herein may be implemented using various types of operating systems (OS), computing platforms, firmware, computer programs, computer languages, and/or general-purpose machines. The method can be run as a programmed process running on processing circuitry. The processing circuitry can take the form of numerous combinations of processors and operating systems, connections and networks, data stores, or a stand-alone device. The process can be implemented as instructions executed by such hardware, hardware alone, or any combination thereof. The software may be stored on a program storage device readable by a machine.

The computer means or computing means or processing means may be operatively associated with the healthcare system communicating with the healthcare application, and is directed by software to compare the first output signal with a first control image and the second output signal with a second control image. The software further directs the computer to produce diagnostic output. Further, a means for transmitting the diagnostic output to an operator of the verification device is included. Thus, many applications of the present disclosure could be formulated. The exemplary network disclosed herein may include any system for exchanging data or transacting business, such as the Internet, an intranet, an extranet, WAN (wide area network), LAN (local area network), satellite communications, and/or the like. It is noted that the network may be implemented as other types of networks.

Additionally, “code” as used herein, or “program” as used herein, may be any plurality of binary values or any executable, interpreted or compiled code which may be used by a computer or execution device to perform a task. This code or program may be written in any one of several known computer languages. A “computer,” as used herein, may mean any device which stores, processes, routes, manipulates, or performs like operation on data. A “computer” may be incorporated within one or more transponder recognition and collection systems or servers to operate one or more processors to run the transponder recognition algorithms. Moreover, computer-executable instructions include, for example, instructions and data which cause a general purpose computer, special purpose computer, or special purpose processing device to perform a certain function or group of functions. Computer-executable instructions also include program modules that may be executed by computers in stand-alone or network environments. Generally, program modules include routines, programs, objects, components, and data structures, etc., that perform particular tasks or implement particular abstract data types.

According to one embodiment of the present disclosure, the components, processes and/or data structures may be implemented using machine language, assembler, C or C++, Java and/or other high level language programs running on a data processing computer such as a personal computer, workstation computer, mainframe computer, or high performance server running an OS such as Solaris® available from Sun Microsystems, Inc. of Santa Clara, Calif., Windows Vista™, Windows NT®, Windows XP PRO, and Windows® 2000, available from Microsoft Corporation of Redmond, Wash., Apple OS X-based systems, available from Apple Inc. of Cupertino, Calif., or various versions of the Unix operating system such as Linux available from a number of vendors. The method may also be implemented on a multiple-processor system, or in a computing environment including various peripherals such as input devices, output devices, displays, pointing devices, memories, storage devices, media interfaces for transferring data to and from the processor(s), and the like. In addition, such a computer system or computing environment may be networked locally, or over the Internet or other networks. Different implementations may be used and may include other types of operating systems, computing platforms, computer programs, firmware, computer languages and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein.

Persons skilled in the art will understand that the devices and methods specifically described herein and illustrated in the accompanying drawings are non-limiting exemplary embodiments. The features illustrated or described in connection with one exemplary embodiment may be combined with the features of other embodiments. Such modifications and variations are intended to be included within the scope of the present disclosure.

The foregoing examples illustrate various aspects of the present disclosure and practice of the methods of the present disclosure. The examples are not intended to provide an exhaustive description of the many different embodiments of the present disclosure. Thus, although the foregoing present disclosure has been described in some detail by way of illustration and example for purposes of clarity and understanding, those of ordinary skill in the art will realize readily that many changes and modifications may be made thereto without departing form the spirit or scope of the present disclosure.

While several embodiments of the disclosure have been shown in the drawings and described in detail hereinabove, it is not intended that the disclosure be limited thereto, as it is intended that the disclosure be as broad in scope as the art will allow. Therefore, the above description and appended drawings should not be construed as limiting, but merely as exemplifications of particular embodiments. Those skilled in the art will envision other modifications within the scope and spirit of the claims appended hereto.

What is claimed is:

1. A method for connecting a patient to a plurality of healthcare facilities in proximity to the patient, the method comprising:
providing a web-based interface portal for medical professionals of each of the plurality of healthcare facilities;
providing a mobile application for the patient on a mobile device, the mobile application communicating with a medical information storage database for storing patient health information;
enabling the patient to conduct a search for the plurality of healthcare facilities in proximity to the patient, in real-time, to create a location-based directory of the plurality of healthcare facilities;
displaying the plurality of healthcare facilities in a prioritized manner based on a combination of estimated travel times to each of the plurality of healthcare facilities and estimated current wait times at each of the plurality of healthcare facilities;
enabling the patient to select a healthcare facility of the plurality of healthcare facilities;
providing at least one transportation option to the patient to the selected healthcare facility; and
notifying the selected healthcare facility of potential surges in patient volume based on one or more inputs by the patient received by the mobile application.

2. The method of claim 1, further comprising enabling the patient to register with the mobile application by inputting at least personal information and medical history information thereto.

3. The method of claim 1, further comprising enabling the medical professionals to create a Quick Response (QR) code via the web-based interface portal, the mobile application on the mobile device of the patient configured to communicate with the QR code when the patient arrives at the selected healthcare facility.

4. The method of claim 1, wherein a range for determining the proximity of the plurality of healthcare facilities to the patient is adjusted by the patient.

5. The method of claim 1, wherein the one or more inputs include placing a call for emergency transportation, placing a call for non-emergency transportation, and loading mapping results derived from prioritizing the plurality of healthcare facilities.

6. The method of claim 1, further comprising continuously and automatically updating the patient health information based on data or information received from wearable devices operated by the patient.

7. The method of claim 1, further comprising transmitting periodic reminders to the patient to update the patient health information.

8. The method of claim 1, wherein, after the patient selects the healthcare facility, the patient is notified of alternative healthcare facilities within proximity to the patient.

9. The method of claim 8, wherein the alternative healthcare facilities are urgent care centers.

10. The method of claim 1, wherein, before the at least one transportation option is selected, the patient transmits the patient health information to the selected healthcare facility.

11. The method of claim 1, wherein, before the at least one transportation option is selected, the patient records a voice message to be transmitted to the selected healthcare facility indicating patient's current condition and/or patient's medical injury.

12. The method of claim 1, wherein, before the at least one transportation option is selected, the patient captures and transmits one or more images and/or videos of an injury to the selected healthcare facility.

13. The method of claim 1, further comprising indicating whether each of the plurality of healthcare facilities in proximity to the patient is compatible with medical insurance of the patient.

14. A method for expedited patient check-in at a healthcare facility, the method comprising:
providing a web-based interface portal for medical professionals of the healthcare facility;
enabling the medical professionals to create a Quick Response (QR) code associated with the healthcare facility via the web-based interface portal;
providing a mobile application for a patient on a mobile device, the mobile application communicating with a medical information storage database for storing patient health information;
establishing proximity between the mobile device of the patient including the mobile application and the healthcare facility having the QR code;
capturing the QR code of the healthcare facility via the mobile application of the mobile device;
establishing communication between the mobile application of the mobile device and the healthcare facility; and
automatically transmitting patient healthcare information from the mobile application to the healthcare facility, the patient healthcare information including at least personal information and medical history information.

15. The method of claim 14, further comprising continuously and automatically updating the patient health information based on data or information received from wearable devices operated by the patient.

16. The method of claim 14, further comprising transmitting periodic reminders to the patient to update the patient health information.

17. The method of claim 14, further comprising accessing the patient health information via the web-based interface portal.

18. The method of claim 14, further comprising allowing each medical professional of the healthcare facility to activate one or more filters on the web-based interface portal to modify the patient health information viewable to that respective medical professional.
